(19) United States
(12) Patent Application Publication
(10) Pub. No.: US 2018/0023486 A1
(43) Pub. Date: Jan. 25, 2018

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Yoshiyuki YAMASHITA, Susono-shi (JP)

(73) Assignee: TOYOTA JIDOSHA KABUSHIKI KAISHA, Toyota-shi (JP)

(21) Appl. No.: 15/654,285

(22) Filed: Jul. 19, 2017

(30) Foreign Application Priority Data
Jul. 21, 2016 (JP) 2016-143428

(51) Int. Cl. F02D 15/04; F02B 75/04

(52) U.S. Cl. CPC F02D 15/04; F02B 75/041

(57) ABSTRACT

A control device of an internal combustion engine 100 provided with a compression ratio control part controlling a mechanical compression ratio to a target compression ratio. The compression ratio control part is configured provided with an optimum compression ratio calculating part calculating an optimum compression ratio in an engine operating state based on the engine operating state, a permittable changed compression ratio calculating part calculating a permittable changed compression ratio giving an effect of improvement of the fuel efficiency even considering the amount of fuel consumed by driving a motor when the optimum compression ratio is higher than a target compression ratio, and a target compression ratio changing part changing the target compression ratio to the permittable changed compression ratio if the optimum compression ratio is higher than the target compression ratio and the optimum compression ratio becomes the permittable changed compression ratio or more.

### CROSS-REFERENCE TO RELATED APPLICATION

This application claims priority based on Japanese Patent Application No. 2016-143428 filed with the Japan Patent Office on Jul. 21, 2016, the entire contents of which are incorporated into the present specification by reference.

### TECHNICAL FIELD

The present disclosure relates to a control device of an internal combustion engine.

### BACKGROUND ART

JP2006-52697A discloses an internal combustion engine provided with a variable compression ratio mechanism configured to be able to change a mechanical compression ratio of an engine body by driving a motor. Further, JP2006-52697A discloses, as a conventional control device for this internal combustion engine, the control device configured so that at the time of controlling the mechanical compression ratio toward an optimum compression ratio (demanded compression ratio) when making the mechanical compression ratio change to a high compression ratio side, it changes a target compression ratio to intentionally retard it toward the optimum compression ratio. Due to this, even if the optimum compression ratio frequently changes, it is possible to suppress changes in the target compression ratio, so it is considered possible to keep the fuel efficiency from deteriorating due to the motor drive loss accompanying an operation for changing the compression ratio.

### SUMMARY OF THE DISCLOSURE

However, in the above-mentioned conventional control device for an internal combustion engine, the target compression ratio is just changed to be intentionally retarded toward the optimum compression ratio, so even if the optimum compression ratio slightly increases, in the end the optimum compression ratio becomes the target compression ratio and the motor is driven to change the mechanical compression ratio toward the optimum compression ratio. For this reason, even if the effect of improvement of the fuel efficiency obtained by changing the mechanical compression ratio to the optimum compression ratio is not commensurate with the amount of fuel consumed by driving the motor (motor drive loss), the motor is driven to change the mechanical compression ratio to the optimum compression ratio. Therefore, even if changing the mechanical compression ratio to the high compression ratio side, it is liable to be impossible to obtain the desired effect of improvement of the fuel efficiency.

The present disclosure was made focusing on this problem and has as its object to change the mechanical compression ratio to the high compression ratio side to thereby obtain the desired effect of improvement of the fuel efficiency.

To solve this problem, according to one aspect of the present disclosure, there is provided a control device of an internal combustion engine for controlling an internal combustion engine provided with an engine body and a variable compression ratio mechanism configured to drive a motor to thereby enable change of a mechanical compression ratio of the engine body, which control device is provided with a compression ratio control part controlling the mechanical compression ratio to a target compression ratio. Further, the compression ratio control part comprises an optimum compression ratio calculating part calculating an optimum compression ratio in the engine operating state based on the engine operating state, a permittable changed compression ratio calculating part calculating a permittable changed compression ratio higher than a target compression ratio giving the effect of improvement of the fuel efficiency even if considering the amount of fuel consumed by driving the motor when the optimum compression ratio is higher than the target compression ratio, and a target compression ratio changing part changing the target compression ratio to the permittable changed compression ratio when the optimum compression ratio is higher than the target compression ratio and the optimum compression ratio becomes the permittable changed compression ratio or more.

According to this aspect of the present disclosure, even if considering the amount of fuel consumed by driving the motor, so long as the effect of improvement of the fuel efficiency is obtained, it is possible to change the target compression ratio to make the mechanical compression ratio change to the high compression ratio side. For this reason, it is possible to make the mechanical compression ratio change to the high compression ratio side to obtain the desired effect of improvement of the fuel efficiency.

### BRIEF DESCRIPTION OF DRAWINGS

FIG. 1 is a view of the general configuration of an internal combustion engine and an electronic control unit controlling the internal combustion engine.

FIG. 2 is a disassembled perspective view of a variable compression ratio mechanism.

FIG. 3A is a view explaining the operation of the variable compression ratio mechanism.

FIG. 3B is a view explaining the operation of the variable compression ratio mechanism.

FIG. 3C is a view explaining the operation of the variable compression ratio mechanism.

FIG. 4 is a view of the general configuration of a variable valve timing mechanism.

FIG. 5 is a view explaining the operation of the variable valve timing mechanism.

FIG. 6A is a view explaining a mechanical compression ratio.

FIG. 6B is a view explaining an actual compression ratio.

FIG. 6C is a view explaining an expansion ratio.

FIG. 7 is a view showing a relationship of a stoichiometric thermal efficiency and an expansion ratio.

FIG. 8 is a view showing operating regions of an engine body.

FIG. 9 is a view showing changes in parameters in accordance with an engine load when making the engine speed constant such as an amount of intake air, intake valve closing timing, mechanical compression ratio, expansion ratio, actual compression ratio, and throttle opening degree.

FIG. 10 is a flow chart explaining a compression ratio control according to a first embodiment of the present disclosure.

FIG. 11 is a flow chart explaining the content of processing for calculating a permittable changed compression ratio according to the first embodiment of the present disclosure.

FIG. 12 is a view showing an added value map for calculating an added value based on an engine speed and a current target compression ratio.

FIG. 13 is a flow chart explaining a control for setting a flag F1.

FIG. 14 is a time chart explaining the operation of compression ratio control according to the first embodiment of the present disclosure.

FIG. 15 is an enlarged view of a part surrounded by broken lines in FIG. 14.

FIG. 16 is a flow chart explaining a motor control according to a second embodiment of the present disclosure.

FIG. 17 is a flow chart explaining the content of processing for calculating a speed switching compression ratio according to the second embodiment of the present disclosure.

FIG. 18 is a view showing a subtracted value map for calculating a subtracted value based on the engine speed and a current target compression ratio.

FIG. 19 is a time chart explaining the operation of motor control according to the second embodiment of the present disclosure.

FIG. 20 is a view explaining a problem in compression ratio control performed in the first embodiment of the present disclosure.

FIG. 21 is a flow chart explaining the content of processing for calculating a permittable changed compression ratio according to a third embodiment of the present disclosure.

FIG. 22 is a view showing a map of a unit amount of fuel consumption.

FIG. 23 is a time chart explaining the operation of a compression ratio control according to the third embodiment of the present disclosure.

### DESCRIPTION OF EMBODIMENTS

Below, referring to the drawings, embodiments of the present disclosure will be explained in detail. Note that, in the following explanation, similar components will be assigned the same reference numerals.

### First Embodiment

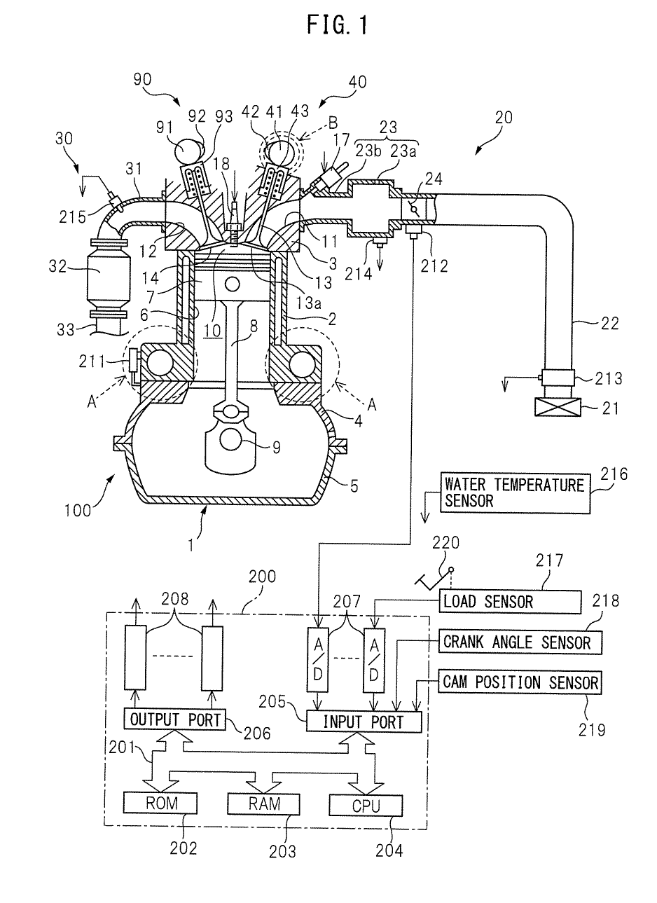

FIG. 1 is a view of the general configuration of an internal combustion engine 100 and an electronic control unit 200 controlling the internal combustion engine 100 according to a first embodiment of the present disclosure.

As shown in FIG. 1, the internal combustion engine 100 is provided with an engine body 1, intake device 20, and exhaust device 30.

The engine body 1 is provided with a cylinder block 2, a cylinder head 3 attached to a top part of the cylinder block 2, a crankcase 4 attached to the bottom part of the cylinder block 2, and an oil pan 5 attached to a bottom part of the crankcase 4.

The cylinder block 2 is formed with a plurality of cylinders 6. Inside the cylinders 6, pistons 7 receiving the combustion pressure and moving reciprocatingly inside the cylinders 6 are held. The pistons 7 are connected through connecting rods 8 to a crankshaft 9 supported inside the crankcase 4 to be able to rotate. The reciprocating motions of the pistons 7 are converted to rotary motion through the crankshaft 9. The spaces defined by the cylinder head 3, cylinders 6, and pistons 7 form the combustion chambers 10.

The cylinder head 3 is formed with intake ports 11 which open to one side surface of the cylinder head 3 (right side in figure) and open to the combustion chambers 10 and exhaust ports 12 which open to the other side surface of the cylinder head 3 (left side in figure) and open to the combustion chambers 10.

Further, the cylinder head 3 is provided with spark plugs 18 for igniting the air-fuel mixture of the fuel injected from the fuel injectors 7 attached to the intake runners 23b of the intake manifold 23 explained later and the air inside the combustion chambers 10 so the spark plugs face the combustion chambers 10. Note that, the fuel injectors 17 may also be attached to the cylinder head 3 so as to directly inject fuel into the combustion chambers 10.

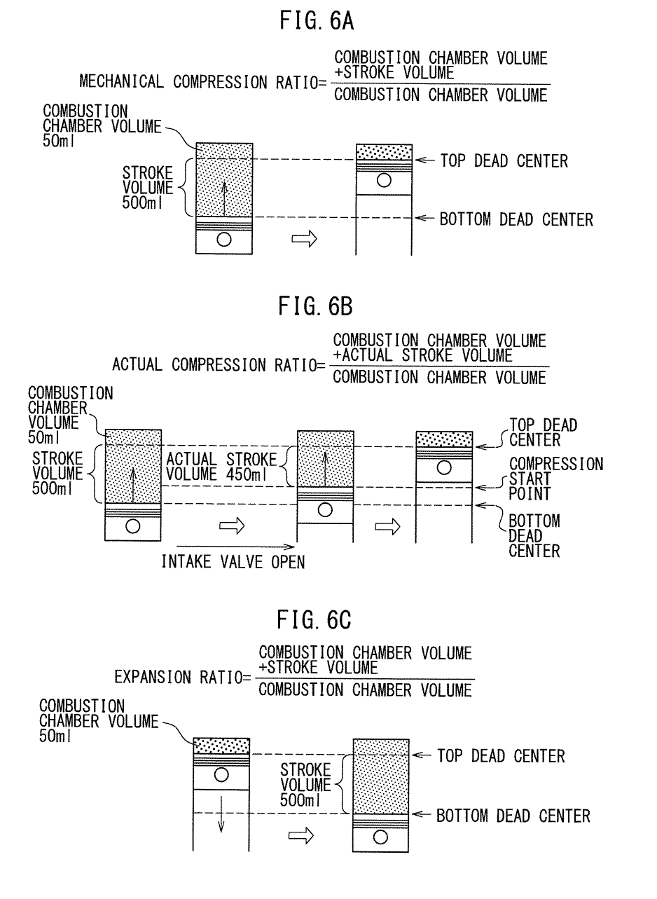

Further, the cylinder head 3 is provided with intake valves 13 for opening and closing the openings with the combustion chambers 10 and intake ports 11 and an intake valve operating device 40 driving operation of the intake valves 13. The intake valve operating device 40 is provided with an intake camshaft 41 extending in the direction of the line of cylinders, intake cams 42 fixed to the intake camshaft 41, tappets 43 contacting the intake cams 42 and pushing down the intake valves, and a variable valve timing mechanism B provided at one end part of the intake camshaft 41 and able to change the closing timings of the intake valves 13 (below, referred to as the “intake valve closing timings”). Details of the variable valve timing mechanism B will be explained later referring to FIG. 5 and FIG. 6.

Furthermore, the cylinder head is provided with exhaust valves 14 for opening and closing the openings with the combustion chambers 10 and exhaust ports 12 and an exhaust valve operating device 90 for driving operation of the exhaust valves 14. The exhaust valve operating device 90 is provided with an exhaust camshaft 91 extending in the direction of the line of the cylinders, exhaust cams 92 fixed to the exhaust camshaft 91, and tappets 93 contacting the exhaust cams 92 and pushing down the exhaust valves.

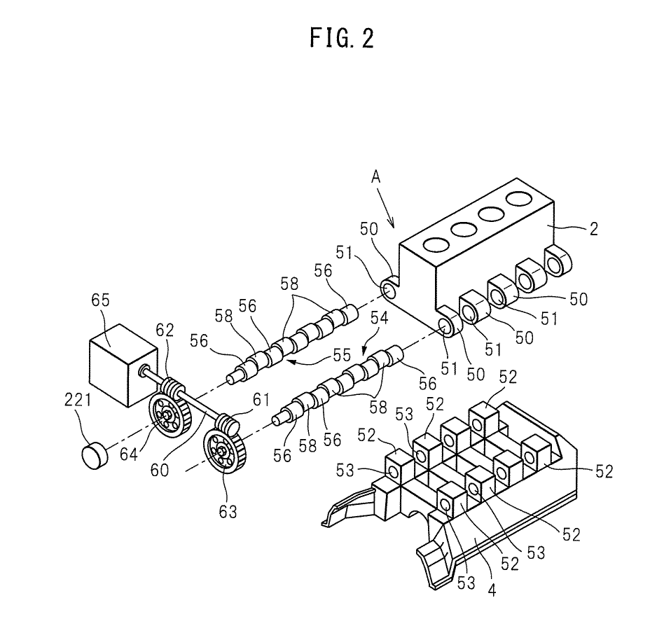

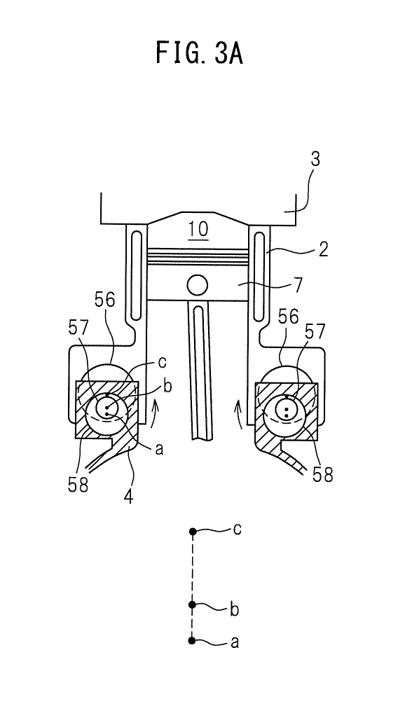

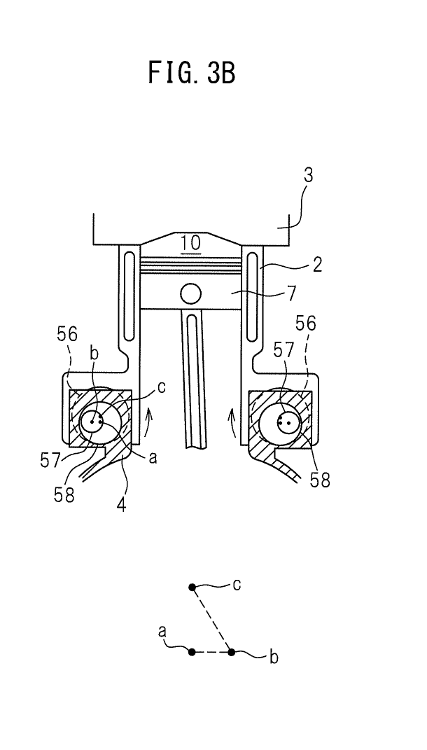

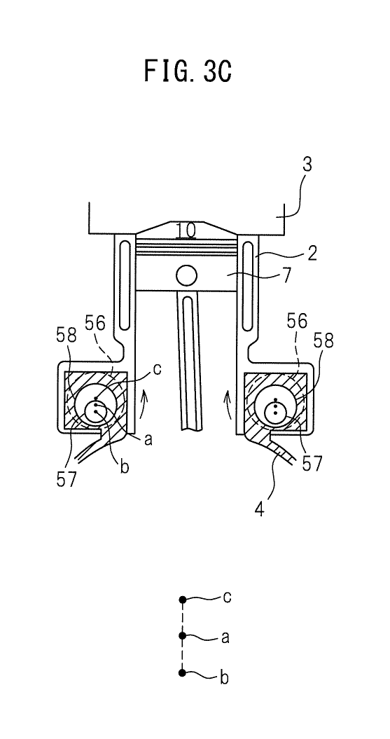

Further, the engine body 1 according to the present embodiment is provided with a variable compression ratio mechanism A at the connecting part of the cylinder block 2 and crankcase 4. The variable compression ratio mechanism A according to the present embodiment changes the volumes of the combustion chambers 10 when the pistons 7 are positioned at compression top dead center by changing the relative position between the cylinder block 2 and the crankcase 4 in the cylinder axial direction. At the connecting part of the cylinder block 2 and the crankcase 4, a relative position sensor 211 for detecting the relative positional relationship between the cylinder block 2 and the crankcase 4 is attached. From this relative position sensor 211, an output signal showing the change in clearance between the cylinder block 2 and crankcase 4 is output. The output signal of the relative position sensor 211 is input through a corresponding AD converter 207 to the electronic control unit 200. The electronic control unit 200 detects the mechanical compression ratio of the engine body 1 based on the output signal of the relative position sensor 211. Details of the variable compression ratio mechanism A will be explained later referring to FIG. 2 and FIG. 3.

The intake device 20 is a device for guiding air through the intake ports 11 to the insides of the cylinders 6 and provided with an air cleaner 21, intake pipe 22, intake manifold 23, electronically controlled throttle valve 24, throttle sensor 212, air flow meter 213, and intake pressure sensor 214.

The air cleaner 21 removes sand and other foreign matter contained in the air.

The intake pipe 22 is connected at one end to the air cleaner 21 and is connected at the other end to a surge tank 23a of the intake manifold 23.

The intake manifold 23 is provided with the surge tank 23a and a plurality of intake runners 23b branching from the surge tank 23a and connecting to the openings of the intake ports 11 formed at the side surface of the cylinder head. The air guided to the surge tank 23a is evenly distributed to the insides of cylinders 6 through the intake runners 23b. In this way, the intake pipe 22, intake manifold 23, and intake ports 11 form intake passages for guiding air to the insides of the cylinders 6.

The throttle valve 24 is provided inside the intake pipe 22. The throttle valve 24 is driven by a throttle actuator (not shown) and changes the passage cross-sectional area of the intake pipe 22 continuously or in stages. By using the throttle actuator to adjust the opening degree of the throttle valve 24 (below, referred to as the “throttle opening degree”), it is possible to adjust the amount of flow of air taken into the cylinders 6. The throttle opening degree is detected by a throttle sensor 212.

The air flow meter 213 is provided inside the intake pipe 22 at the upstream side from the throttle valve 24. The air flow meter 213 detects the amount of flow of the air flowing through the inside of the intake pipe 22 (below, referred to as the “suction intake amount”).

The intake pressure sensor 214 is provided inside the surge tank 23a. The intake pressure sensor 214 detects the pressure inside the surge tank 23a.

The exhaust device 30 is a device for purifying combustion gas (exhaust) produced inside the combustion chambers 10 and discharging it to the outside air and is provided with an exhaust manifold 31, exhaust post-treatment device 32, exhaust pipe 33, and air-fuel ratio sensor 215.

The exhaust manifold 31 is provided with a plurality of exhaust runners connected with openings of the exhaust ports 12 formed at a side surface of the cylinder head and a header pipe collecting the exhaust runners into a single pipe.

The exhaust post-treatment device 32 is connected to the header pipe of the exhaust manifold 31. The exhaust post-treatment device 32 is a device for purifying the exhaust, then discharging it to the outside air and comprises various types of catalysts removing harmful substances (for example, three-way catalyst) supported on a support.

The exhaust pipe 33 is connected at one end to the exhaust post-treatment device 32. The other end forms the open end. The exhaust discharged from the cylinders 6 through the exhaust ports 12 to the exhaust manifold 31 flows through the exhaust post-treatment device 32 and exhaust pipe 33 to be discharged to the outside air.

The air-fuel ratio sensor 215 is provided at the header pipe of the exhaust manifold 31 and detects the air-fuel ratio of the exhaust.

The electronic control unit 200 is configured by a digital computer and is provided with components connected with each other by a bidirectional bus 201 such as a ROM (read only memory) 202, RAM (random access memory) 203, CPU (microprocessor) 204, input port 205, and output port 206.

The input port 205 receives as input the output signals of the above-mentioned relative position sensor 211 or throttle sensor 212, air flow meter 213, intake pressure sensor 214, air-fuel ratio sensor 215, etc. and also output signals from a water temperature sensor 216 for detecting the temperature of the cooling water for cooling the engine body 1 etc. through the corresponding AD converters 207. Further, the input port 205 receives as input an output voltage of a load sensor 217 generating an output voltage proportional to the amount of depression of an accelerator pedal 220 (below, referred to as the “amount of accelerator depression”) through a corresponding AD converter 207. Further, the input port 205 receives as input an output signal of a crank angle sensor 218 generating an output pulse every time the crankshaft 9 of the engine body 1 rotates by for example 15° as a signal for calculating the engine speed etc. Furthermore, the input port 205 receives as input an output signal of a cam position sensor 219 generating a signal expressing a rotational angle of the intake camshaft. In this way, the input port 205 receives as input the output signals of various types of sensors required for controlling the internal combustion engine 100.

The output port 206 is electrically connected through corresponding drive circuits 208 to the fuel injectors 17, spark plugs 18, variable compression ratio mechanism A, variable valve timing mechanism B, and other control parts.

The electronic control unit 200 outputs control signals for controlling the control parts from the output port 206 to control the internal combustion engine 100 based on the output signals of the various sensors input to the input port 205.

FIG. 2 is a disassembled perspective view of the variable compression ratio mechanism A according to the present embodiment.

As shown in FIG. 2, a plurality of projecting parts 50 spaced apart from each other are formed at the bottoms of the two side walls of the cylinder block 2. The projecting parts 50 are formed with circular cross-section cam insertion holes 51. On the other hand, a plurality of projecting parts 52 spaced apart from each other and fitting between the corresponding projecting parts 50 are formed on the top wall surface of the crankcase 4. These projecting parts 52 are formed with circular cross-section cam insertion holes 53.

Further, the variable compression ratio mechanism A is provided with a pair of camshafts 54, 55. On the camshafts 54, 55, circular cams 58 spaced apart by predetermined distances and designed to be inserted in the cam insertion holes 53 to be able to rotate are fixed. These circular cams 58 are coaxial with the axes of rotation of the camshafts 54, 55. On the other hand, at the two sides of the circular cams 58, eccentric shafts 57 arranged eccentrically with respect to the axes of rotation of the camshafts 54, 55 (see FIG. 3A to FIG. 3C) extend. On these eccentric shafts 57, other circular cams 56 are attached eccentrically to be able to rotate. As shown in FIG. 2, these circular cams 56 are arranged at the two sides of the circular cams 58. These circular cams 56 are inserted to be able to rotate into the corresponding cam insertion holes 51.

At first end parts of the camshafts 54, 55, a pair of worms 61, 62 provided at the control shaft 60 and worm wheels 63, 64 engaged with the same are attached. The pair of worms 61, 62 have opposite spiral directions so as to enable the camshafts 54, 55 to be made to rotate in opposite directions. The control shaft 60 is made to rotate by the motor 65. By making the motor 65 turn and making the camshafts 54, 55 rotate in opposite directions, as shown in FIG. 3A to FIG. 3C, the volumes of the combustion chambers 10 when the pistons 7 are positioned at compression top dead center are made to change. At the camshaft 55, a cam rotational angle sensor 221 generating an output signal expressing the angle of rotation of the camshaft 55 is attached. The output signal of the cam rotational angle sensor 221 is input through the corresponding AD converter 207 to the electronic control unit 200. Below, referring to FIG. 3A to FIG. 3C, the operation of the variable compression ratio mechanism A will be explained.

FIG. 3A to FIG. 3C are views explaining the operation of the variable compression ratio mechanism A.

FIG. 3A is a view of the state where the variable compression ratio mechanism A is used to make the volume of each combustion chamber 10 when the piston 7 is positioned at compression top dead center the maximum, that is, the state where the mechanical compression ratio is made the minimum. FIG. 3B is a view of the state where the variable compression ratio mechanism A is used to make the volume of each combustion chamber 10 when the piston 7 is positioned at compression top dead center a volume between the maximum and minimum, that is, the state where the mechanical compression ratio is made a ratio between the minimum and the maximum. FIG. 3C is a view of the state where the variable compression ratio mechanism A is used to make the volume of each combustion chamber 10 when the piston 7 is positioned at compression top dead center the minimum, that is, the state where the mechanical compression ratio is the maximum.

If making the circular cams 58 fixed on the camshafts 54, 55 rotate in opposite directions from each other from the state shown in FIG. 3A as shown by the arrows in FIG. 3A, the eccentric shafts 57 move in directions away from each other, so the circular cams 56 rotate in opposite directions from the circular cams 58 inside the cam insertion holes 51. Due to this, as shown in FIG. 3B, the positions of the eccentric shafts 57 shift from the high positions to the medium height positions. Next, further, if making the circular cams 58 rotate in the directions shown by the arrows, as show in FIG. 3C, the eccentric shafts 57 become the lowest positions.

Note that FIG. 3A to FIG. 3C show the positional relationships among a center “a” of a circular cam 58, a center “b” of an eccentric shaft 57, and a center “c” of a circular cams 56 in their respective states.

As will be understood if comparing FIG. 3A to FIG. 3C, the relative position of the crankcase 4 and the cylinder block 2 is determined by the distance between the centers “a” of the circular cams 58 and the centers “c” of the circular cams 56. The larger the distance between the centers “a” of the circular cams 58 and the centers “c” of the circular cams 56, the more the cylinder block 2 moves to the side away from the crankcase 4. That is, the variable compression ratio mechanism A according to the present embodiment changes the relative position between the crankcase 4 and cylinder block 2 by a crank mechanism using rotating cams. If the cylinder block 2 separates from the crankcase 4, the volume of each combustion chamber 10 when the piston 7 is positioned at compression top dead center increases. In this way, by making the camshafts 54, 55 rotate, the volume of each combustion chamber 10 when the piston 7 is positioned at compression top dead center can be changed.

Note that, the variable compression ratio mechanism A shown in FIG. 1 and FIG. 2 shows one example. For example, like in the above-mentioned conventional internal combustion engine (internal combustion engine described in Japanese Patent Publication No. 2006-52697A), it is also possible to provide an upper link with one end connected to a piston through a piston pin, a lower link to which the other end of the upper link and a crankpin of the crankshaft are connected, a control shaft arranged substantially in parallel with the crankshaft, and a control link with one end connected to the control shaft to be able to swing and with the other end connected to the lower link and configure the mechanism so as to be able to make the control shaft rotate by a motor so as to change the piston top dead center position and change the mechanical compression ratio.

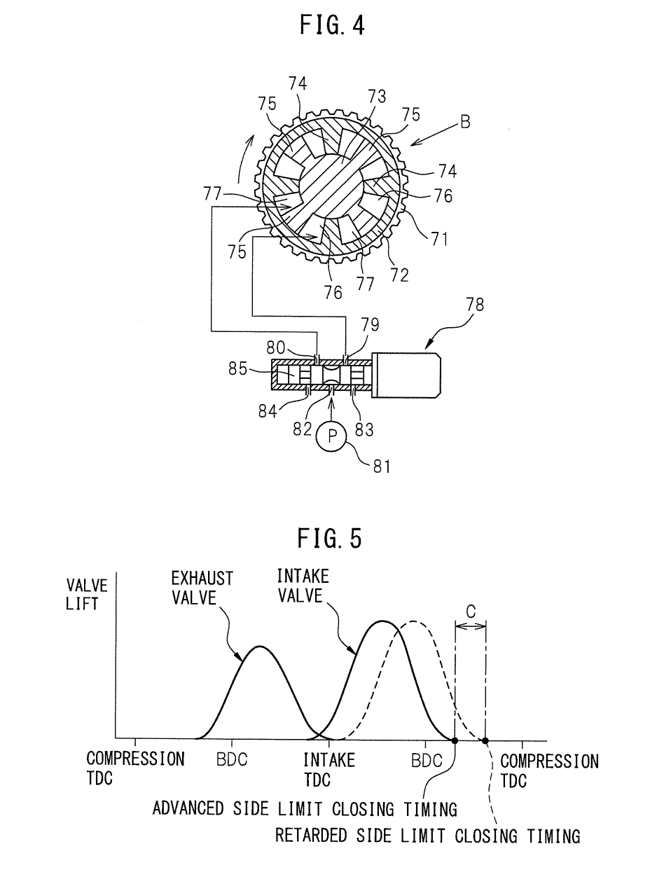

FIG. 4 is a view of the general configuration of the variable valve timing mechanism B according to the present embodiment provided at one end part of the intake camshaft 41.

As shown in FIG. 4, the variable valve timing mechanism B is provided with a timing pulley 71 made to rotate by the crankshaft 9 through a timing belt in the arrow direction, a tubular housing 72 rotating together with the timing pulley 71, a shaft 73 rotating together with the intake camshaft 41 and able to rotate relative to the tubular housing 72, a plurality of partition walls 74 extending from the inner circumferential surface of the tubular housing 72 to the outer circumferential surface of the shaft 73, and vanes 75 extending between the partition walls 74 and extending from the outer circumferential surface of the shaft 73 to the inner circumferential surface of the tubular housing 72. At the two sides of each vane 75, an advancing-use hydraulic chamber 76 and a retarding-use hydraulic chamber 77 are formed.

The feed of the hydraulic oil to the hydraulic chambers 76, 77 is controlled by a hydraulic oil feed control valve 78 driven by the electronic control unit 200. The hydraulic oil feed control valve 78 is provided with hydraulic ports 79, 80 respectively connected to the hydraulic chambers 76, 77, a feed port 82 of hydraulic oil discharged from a hydraulic pump 81, a pair of drain ports 83, 84, and a spool valve 85 controlling communication and cutoff among the ports 79, 80, 82, 83, and 84.

When the phases of the intake cams 42 of the intake camshaft 41 should be advanced, in FIG. 4, the spool valve 85 is made to move to the right, hydraulic oil fed from the feed port 82 is fed through the hydraulic port 79 to the advancing-use hydraulic chambers 76, and hydraulic oil in the retarding-use hydraulic chambers 77 is discharged from the drain port 84. At this time, the shaft 73 is made to rotate relatively with respect to the tubular housing 72 in the arrow direction.

As opposed to this, when retarding the phases of the intake cams 42 of the intake camshaft 41, in FIG. 4, the spool valve 85 is made to move to the left, hydraulic oil fed from the feed port 82 is fed through the hydraulic port 80 to the retarding-use hydraulic chambers 77, and hydraulic oil in the advancing-use hydraulic chambers 76 is discharged from the drain port 83. At this time, the shaft 73 is made to rotate relative to the tubular housing 72 in the opposite direction from the arrow.

When the shaft 73 is made to rotate relative to the tubular housing 72, if the spool valve 85 is returned to the neutral position shown in FIG. 4, the relative rotation operation of the shaft 73 is made to stop and the shaft 73 is held at the relative rotation position at that time. In this way, the variable valve timing mechanism B may be used to make the phases of the intake cams 42 of the intake camshaft 41 advance or be retarded by exactly the desired amount.

FIG. 5 is a view explaining the operation of the variable valve timing mechanism B.

The solid line in FIG. 5 shows the lift curve when the phase of an intake cam 42 of the intake camshaft 41 is advanced the most by the variable valve timing mechanism B, while the broken line in FIG. 5 shows the lift curve when the phase of an intake cam 42 of the intake camshaft 41 is retarded the most. Therefore, the opening time period of the intake valve 13 can be freely set within the range shown by the solid line in FIG. 5 and the range shown by the broken line, while the intake valve closing timing also can be set to any crank angle in the range shown by the arrow C in FIG. 5.

That is, using the variable valve timing mechanism B, it is possible to change an intake valve closing timing to any timing from the closing timing when the phase of the intake cam 42 of the intake camshaft 41 is advanced the most (below, referred to as the “advanced side limit closing timing”) to the closing timing when the phase of the intake cam 42 of the intake camshaft 41 is retarded the most (below, referred to as the “retarded side limit closing timing”).

Note that, the variable valve timing mechanism B shown in FIG. 1 and FIG. 4 is one example. For example, a variable valve timing mechanism able to change only an intake valve closing timing while maintaining an intake valve opening timing constant and other various types of variable valve timing mechanisms can be used.

Next, referring to FIG. 6A to FIG. 6C, the meanings of the terms used in the Description such as the “mechanical compression ratio”, the “actual compression ratio”, and the “expansion ratio” will be explained. Note that, FIG. 6A to FIG. 6C show the engine body 1 with a combustion chamber volume of 50 ml and a stroke volume of a piston 7 of 500 ml for explaining the terminology. In these FIG. 6A to FIG. 6C, the “combustion chamber volume” expresses the volume of a combustion chamber 10 when the piston 7 is positioned at compression top dead center.

FIG. 6A is a view explaining the mechanical compression ratio.

The mechanical compression ratio is a value determined mechanically from only the stroke volume of a piston 7 at the time of the compression stroke and the combustion chamber volume and is represented by (combustion chamber volume+stroke volume)/combustion chamber volume. In the example shown in FIG. 6A, the mechanical compression ratio becomes (50 ml+500 ml)/50 ml=11.

FIG. 6B is a view explaining the actual compression ratio.

The actual compression ratio is a value determined from an actual piston stroke volume from when a compression action actually is started to when a piston 7 reaches top dead center and the combustion chamber volume and is represented by the (combustion chamber volume+the actual stroke volume)/combustion chamber volume. That is, as shown in FIG. 6B, in the compression stroke, even if the piston 7 starts rising, the compression action is not performed while the intake valve 13 is open. The actual compression action is started after the intake valve 13 is closed. Therefore, the actual compression ratio is expressed as follows using the actual stroke volume. In the example shown in FIG. 6B, the actual compression ratio becomes (50 ml+450 ml)/50 ml=10.

FIG. 6C is a view explaining the expansion ratio.

The expansion ratio is a value determined from the stroke volume of a piston 7 at the time of the expansion stroke and the combustion chamber volume and is expressed by (combustion chamber volume+stroke volume)/combustion chamber volume. In the example shown in FIG. 6C, the expansion ratio becomes (50 ml+500 ml)/50 ml=11.

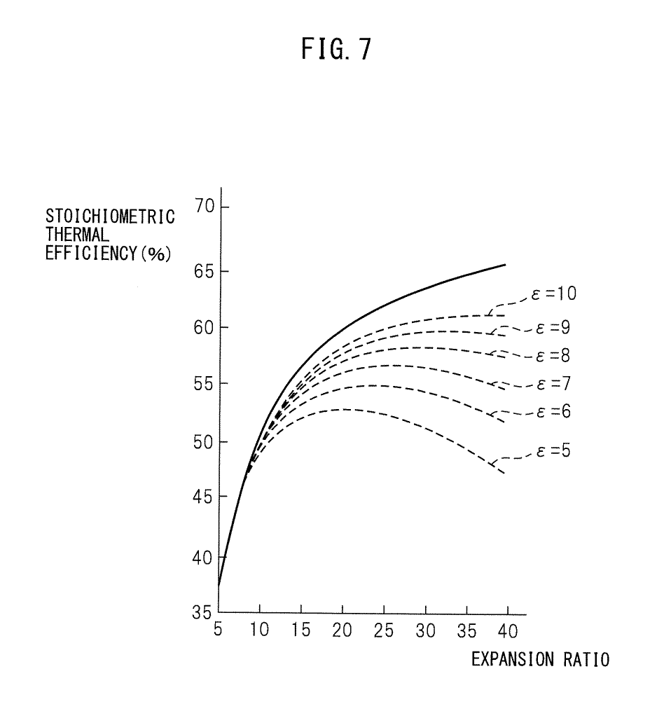

FIG. 7 is a view showing the relationship between the stoichiometric thermal efficiency and the expansion ratio.

The solid line in FIG. 7 shows the change in the stoichiometric thermal efficiency in a normal cycle where the actual compression ratio and the expansion ratio become substantially equal. In this case, it is learned that the larger the expansion ratio, that is, the higher the actual compression ratio, the higher the stoichiometric thermal efficiency. Therefore, in a normal cycle, to raise the stoichiometric thermal efficiency, it is sufficient to raise the actual compression ratio. However, due to the restrictions on the occurrence of knocking at the time of engine high load operation, the actual compression ratio can only be raised to a certain extent. Therefore, in a normal cycle, the stoichiometric thermal efficiency cannot be sufficiently raised.

On the other hand, in view of such a situation, strictly separating the mechanical compression ratio and the actual compression ratio and raising the stoichiometric thermal efficiency has been studied. As a result, it was learned that the stoichiometric thermal efficiency is governed by the expansion ratio and that the effect of the actual compression ratio on the stoichiometric thermal efficiency is relatively small. That is, it was learned that if raising the actual compression ratio, the explosive force rises, but the energy required for compression becomes larger and, as a result, even if raising the actual compression ratio, the stoichiometric thermal efficiency does not rise much at all.

As opposed to this, if increasing the expansion ratio, the time period during which a downward pushing force acts on a piston 7 at the time of the expansion stroke becomes longer and the time period during which a piston 7 gives a rotating force to the crankshaft 9 becomes longer. Therefore, the larger the expansion ratio, the higher the stoichiometric thermal efficiency. In FIG. 7, the broken line 8=10 shows the stoichiometric thermal efficiency when raising the expansion ratio in the state fixing the actual compression ratio at 10. In this way, it is learned that there is no great difference between the amount of rise of the stoichiometric thermal efficiency when raising the expansion ratio in the state maintaining the actual compression ratio ε at a low value and the amount of rise of the stoichiometric thermal efficiency when the actual compression ratio shown by the solid line in FIG. 7 increases together with the expansion ratio.

If in this way the actual compression ratio is maintained at a low value, knocking will not occur. Therefore, if raising the expansion ratio in the state where the actual compression ratio is maintained at a low value, the occurrence of knocking can be prevented while the stoichiometric thermal efficiency can be greatly improved. Further, in general, an internal combustion engine tends to become poorer in thermal efficiency the lower the engine load, so to improve the thermal efficiency at the time of engine operation and improve the fuel efficiency, it is effective to improve the thermal efficiency when the engine load is low.

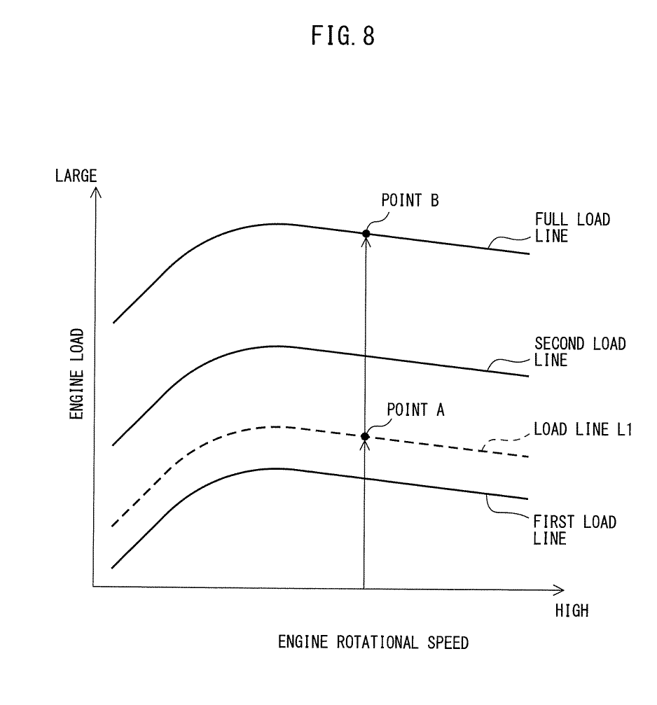

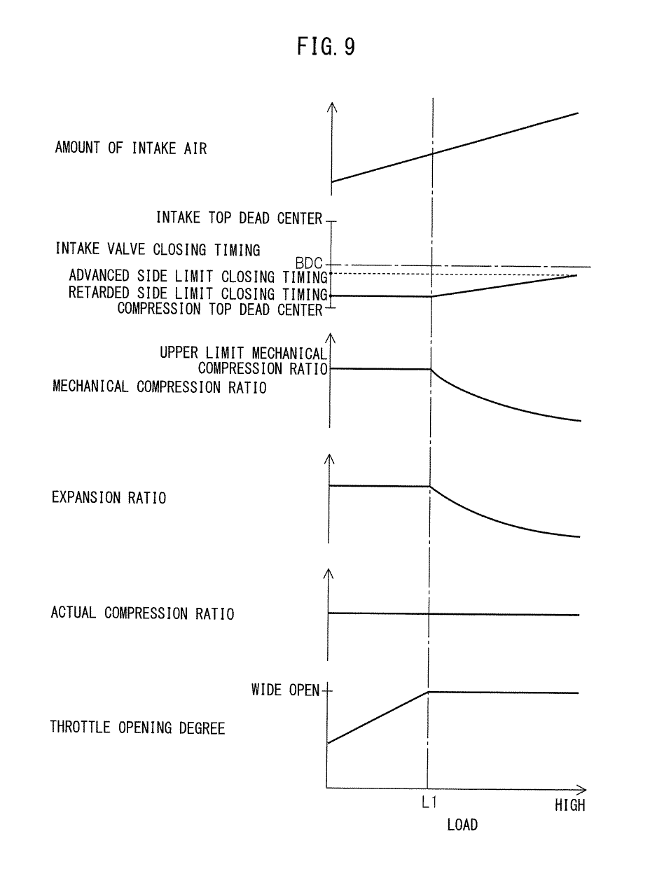

Below, referring to FIG. 8 and FIG. 9, the basic control of the variable compression ratio mechanism A and variable valve timing mechanism B according to the present embodiment will be explained.

FIG. 8 is a view showing operating regions of the engine body 1. Below, for convenience, the region of a first load line or less when dividing the operating regions of the engine body 1 by the first load line and a second load line into three equal parts will be referred to as the “low load region”. The region of the second load line or less not including the low load region will be referred to as the “medium load region”. The region of an engine load higher than the second load line will be referred to as the “high load region”. FIG. 9 is a view showing the changes in parameters corresponding to the engine load when making the engine speed constant in FIG. 8 such as the amount of intake air, intake valve closing timing, mechanical compression ratio, expansion ratio, actual compression ratio, and throttle opening degree.

When the engine operating state determined based on the engine speed and the engine load is in a region of the load line L1 present in the medium load region shown in FIG. 8 at the somewhat first load line side or less, as shown in FIG. 9, the electronic control unit 200 fixes the intake valve closing timing at a retarded side limit closing timing retarded the most from intake bottom dead center and controls the amount of intake air by the throttle valve 24 and fixes the mechanical compression ratio at the upper limit mechanical compression ratio. Note that the “upper limit mechanical compression ratio” is the mechanical compression ratio when the combustion chamber volume is made the smallest (state of FIG. 3C).

In this way, when the engine operating state is in the region of the load line L1 or less, the electronic control unit 200 fixes the mechanical compression ratio at the upper limit mechanical compression ratio to thereby maintain the expansion ratio at the maximum expansion ratio and fixes the intake valve closing timing at the retarded side limit closing timing to thereby maintain the actual compression ratio at a predetermined reference compression ratio where knocking and preignition do not occur (in the present embodiment, 11).

When applied to the engine body 1 shown in FIG. 6A to FIG. 6C, by fixing the intake valve closing timing at the retarded side limit closing timing, for example, the actual piston stroke volume becomes 500 ml to 200 ml. By fixing the mechanical compression ratio to the upper limit mechanical compression ratio, for example, the combustion chamber volume becomes 50 ml to 20 ml. Therefore, in the engine body 1 shown in FIG. 6A to FIG. 6C, when the engine operating state is in the low load region, the actual compression ratio becomes (20 ml+200 ml)/20 ml=11 and the expansion ratio becomes (20 ml+500 ml)/20 ml=26.

Due to this, in the region of the load line L1 or less, the actual compression ratio is maintained at a reference compression ratio where knocking does not occur while the expansion ratio can be maintained at the maximum expansion ratio, so it is possible to keep knocking from occurring while greatly raising the stoichiometric thermal efficiency.

Further, when the engine operating state is in the region of the load line L1 or less, the electronic control unit 200 controls the throttle valve 24 so that the amount of intake air becomes a target amount of intake air corresponding to the engine load.

Specifically, as shown in FIG. 9, if the engine speed is constant, when the engine load is present at the point A of the load line L1 shown in FIG. 8, the throttle opening degree is made larger the higher the engine load so that the throttle valve 24 becomes wide open. For this reason, if the engine load becomes higher than the load line L1, it soon becomes impossible to use the throttle valve 24 to control the amount of intake air. Therefore, when the engine load becomes higher than the load line L1, the intake valve closing timing is advanced from the retarded side limit closing timing to the intake bottom dead center side so as to make the amount of intake air increase.

That is, when the engine operating state is in a region higher than the load line L1, the electronic control unit 200 fixes the throttle valve 24 at wide open and controls the amount of intake air by the variable valve timing mechanism B and lowers the mechanical compression ratio from the upper limit mechanical compression ratio so that the actual compression ratio is maintained at the reference compression ratio.

Specifically, as shown in FIG. 9, when the engine speed is constant, the electronic control unit 200 advances the intake valve closing timing from the retarded side limit closing timing to the intake bottom dead center side more the higher the engine load so as to make the amount of intake air increase so that the intake valve closing timing becomes the advanced side limit closing timing when the engine load is present at the point B on the full load line shown in FIG. 8. Further, the electronic control unit 200 reduces the mechanical compression ratio from the upper limit mechanical compression ratio more the higher the engine load so that the actual compression ratio is maintained at the reference compression ratio.

In the engine body 1 shown in FIG. 6A to FIG. 6C, if making the intake valve closing timing advance from the retarded side limit closing timing to the intake bottom dead center point side so that for example the actual piston stroke volume becomes 500 ml to 400 ml, to maintain the actual compression ratio at a predetermined reference compression ratio (in the present embodiment, 11), the electronic control unit 200 lowers the mechanical compression ratio so that the combustion chamber volume becomes 40 ml.

In this way, in the region higher than the load line L1, the intake valve closing timing is controlled toward the advanced side limit closing timing. To maintain the actual compression ratio, which changes according to the intake valve closing timing, at a reference compression ratio, the mechanical compression ratio is made smaller than the upper limit mechanical compression ratio. For this reason, even in the region higher than the load line L1, the expansion ratio becomes smaller than the maximum expansion ratio, but it is possible to continue to make the engine body 1 operate in the state with the expansion ratio maintained at a value higher than the actual compression ratio. Accordingly, even in the region higher than the load line L1, it is possible to suppress the occurrence of knocking while raising the stoichiometric thermal efficiency. Further, in the region higher than the load line L1, the throttle valve 24 is fixed to wide open, so the pumping loss can be made substantially zero.

In this way, in the present embodiment, by cooperatively controlling the variable compression ratio mechanism A and variable valve timing mechanism B based on the engine operating state, in all operating regions, the engine body 1 is operated in a state maintaining the actual compression ratio at a reference compression ratio where no knocking occurs while raising the expansion ratio over the actual compression ratio.

Next, the detailed control of the variable compression ratio mechanism A according to the present embodiment will be explained.

In the case of the internal combustion engine 100 provided with the variable compression ratio mechanism A, there is, for each engine operating state, a mechanical compression ratio where it is possible to operate the engine body 1 in the state suppressing occurrence of knocking while raising the stoichiometric thermal efficiency the most (below, referred to as the “optimum compression ratio”). This optimum compression ratio, in other words, is a mechanical compression ratio where it is considered that the fuel efficiency becomes the best in a certain engine operating state.

Here, the electronic control unit 200 controls the variable compression ratio mechanism A so that the mechanical compression ratio becomes the target compression ratio. Therefore, it may be thought desirable to set the target compression ratio at the optimum compression ratio and control the variable compression ratio mechanism A so that the mechanical compression ratio becomes the optimum compression ratio corresponding to the engine operating state.

However, to use the variable compression ratio mechanism A to change the mechanical compression ratio, it is necessary to drive the motor 65 to make the control shaft 60 rotate. At this time, power for driving the motor 65 is consumed. The power consumed when driving this motor 65 is the power generated by the drive force of the engine body 1 and stored in the battery. Therefore, when driving the motor 65, it can be said that fuel of the amount of drive power required for generating the electric power consumed at this time is consumed.

If the optimum compression ratio changes to the high compression ratio side along with the change of the engine operating state, when the amount of change of the optimum compression ratio (amount of increase) is small, even if controlling the mechanical compression ratio to the optimum compression ratio to raise the stoichiometric thermal efficiency, the amount of rise of the stoichiometric thermal efficiency is small and therefore the effect of improvement of the fuel efficiency obtained by raising the stoichiometric thermal efficiency is also small. For this reason, when the amount of increase of the optimum compression ratio is small, even if controlling the mechanical compression ratio to the optimum compression ratio to raise the stoichiometric thermal efficiency, the effect of improvement of the fuel efficiency obtained by raising the stoichiometric thermal efficiency will sometimes not be commensurate with the amount of fuel consumed by driving the motor 65. That is, despite the amount of change of the optimum compression ratio being small, if controlling the mechanical compression ratio to the optimum compression ratio each time, for example, when the optimum compression ratio frequently rises and falls etc., even if controlling the mechanical compression ratio to the optimum compression ratio to raise the stoichiometric thermal efficiency, the effect on the amount of fuel consumed by driving the motor 65 becomes large and conversely the fuel efficiency deteriorates and the desired effect of improvement of the fuel efficiency sometimes cannot be obtained.

Therefore, in the present embodiment, when the optimum compression ratio changes to the high compression ratio side along with the change of the engine operating state, even if considering the amount of fuel consumed by driving the motor 65, so long as the effect of improvement of the fuel efficiency is obtained, the target compression ratio is changed and the mechanical compression ratio is made to change to the high compression ratio side.

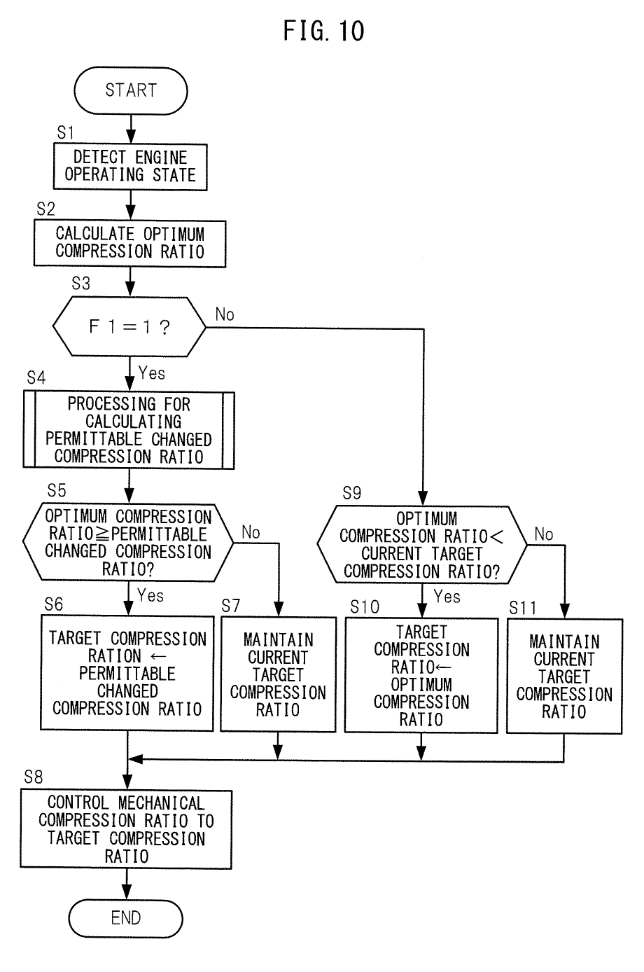

Below, referring to FIG. 10 to FIG. 13, the content of the compression ratio control according to this present embodiment will be explained.

FIG. 10 is a flow chart explaining the compression ratio control according to the present embodiment. The electronic control unit 200 repeatedly performs this control by a predetermined processing period Δt (for example 10 ms).

At step S1, the electronic control unit 200 reads the engine load detected by the load sensor 217 and the engine speed calculated based on the output signal of the crank angle sensor 218 and detects the engine operating state.

At step S2, the electronic control unit 200 refers to a map prepared in advance by experiments etc. to calculate the optimum compression ratio based on the engine operating state. In the present embodiment, when the engine operating state is within the operating region of the load line L1 or less of FIG. 8, the upper limit mechanical compression ratio is made the optimum compression ratio. Further, when the engine operating state is within the operating region higher than the load line L1 of FIG. 8, a mechanical compression ratio lower than the upper limit mechanical compression ratio is made the optimum compression ratio.

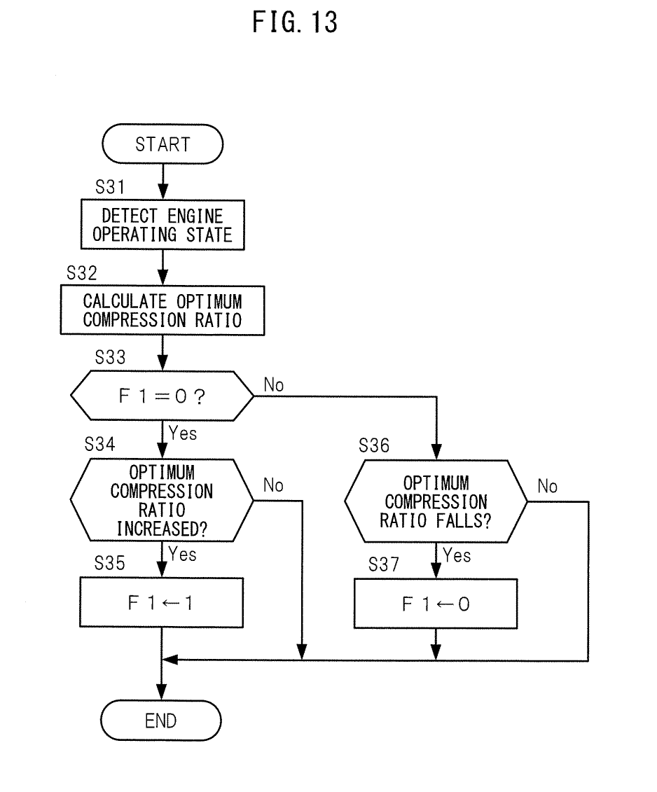

At step S3, the electronic control unit 200 reads the value of the flag F1 set as needed during engine operation separate from the present routine and judges if the flag F1 is set to “1”. The flag F1 is a flag with an initial value set to “0”. When the optimum compression ratio starts to increase along with the change of the engine operating state, this set to “1”, while the optimum compression ratio is returned to “0” when the ratio starts to decrease. The electronic control unit 200 proceeds to step S4 if the flag F1 is set to “1”. On the other hand, the electronic control unit 200 proceeds to step S9 if the flag F1 is set to “0”. Note that, the control for setting the flag F1 will be explained later with reference to FIG. 13.

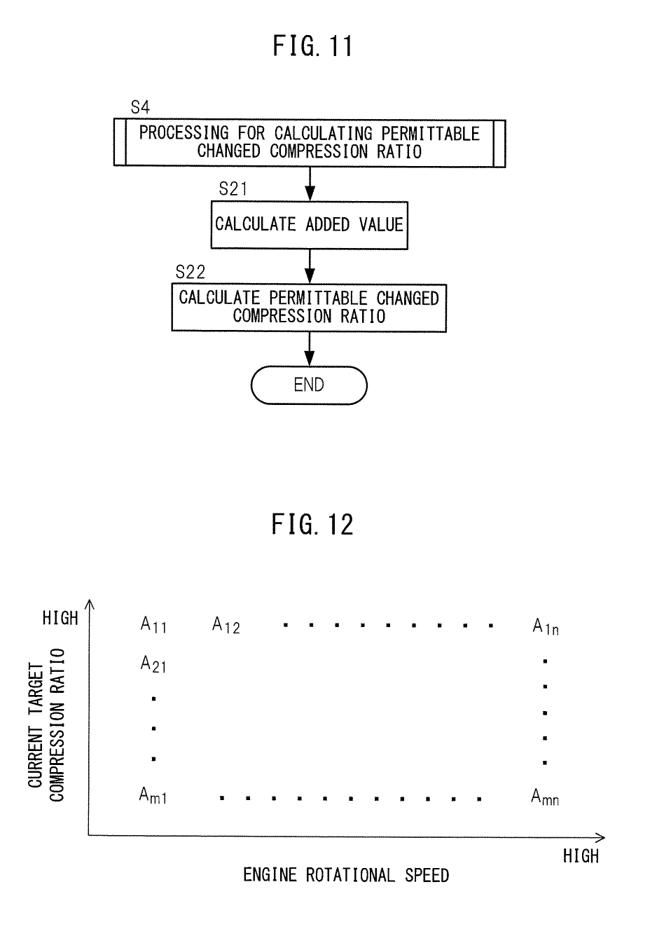

At step S4, the electronic control unit 200 performs processing for calculating a permittable changed compression ratio. The processing for calculating a permittable changed compression ratio is processing for calculating the mechanical compression ratio at the high compression ratio side from the current target compression ratio (below, referred to as the “permittable changed compression ratio”) giving an effect of improvement of the fuel efficiency even if considering the amount of fuel consumed by driving the motor 65 in the case of changing the target compression ratio to a target compression ratio higher than the current target compression ratio (below, referred to as the “current target compression ratio”). The detailed content of the processing for calculating a permittable changed compression ratio will be explained later referring to FIG. 11.

At step S5, the electronic control unit 200 judges if the optimum compression ratio is the permittable changed compression ratio or more. The electronic control unit 200 judges that the effect of improvement of the fuel efficiency can be obtained even if considering the amount of fuel consumed by driving the motor 65 if the optimum compression ratio is the permittable changed compression ratio or more, then proceeds to step S6. On the other hand, if the optimum compression ratio is less than the permittable changed compression ratio, the electronic control unit 200 judges that the desired effect of improvement of the fuel efficiency cannot be obtained even if controlling the mechanical compression ratio to the optimum compression ratio and proceeds to the processing of step S7.

At step S6, the electronic control unit 200 sets the target compression ratio to the permittable changed compression ratio.

At step S7, the electronic control unit 200 does not change the target compression ratio but leaves the target compression ratio as the current target compression ratio.

At step S8, the electronic control unit 200 controls the variable compression ratio mechanism A so that the mechanical compression ratio becomes the target compression ratio. At this time, in the present embodiment, the unit controls the motor 65 so that the rotational speed of the motor 65 (below, referred to as the “motor rotational speed”) becomes the highest rotational speed. Due to this, if it is judged that the effect of improvement of the fuel efficiency is obtained even if considering the amount of fuel consumed by driving the motor 65, it is possible to quickly control the mechanical compression ratio toward the target compression ratio, so it is possible to quickly obtain the effect of improvement of the fuel efficiency by raising the stoichiometric thermal efficiency.

At step S9, the electronic control unit 200 judges if the optimum compression ratio is less than the current target compression ratio. The electronic control unit 200 proceeds to step S10 if the optimum compression ratio is less than the current target compression ratio. On the other hand, if the optimum compression ratio is higher than the current target compression ratio, the electronic control unit 200 proceeds to step S11.

At step S10, the electronic control unit 200 sets the target compression ratio at the optimum compression ratio.

At step S11, the electronic control unit 200 does not change the target compression ratio but leaves the target compression ratio as the current target compression ratio.

FIG. 11 is a flow chart explaining the content of processing for calculating a permittable changed compression ratio according to the present embodiment.

At step S21, the electronic control unit 200 refers to the added value map of FIG. 12 to calculate the added value A to be added to the current target compression ratio to calculate the permittable changed compression ratio based on the engine speed and the current target compression ratio.

The added value map is configured so that if the engine speed is the same, the added value A becomes larger the higher the current target compression ratio. That is, the added value map is configured so that changing the target compression ratio becomes difficult the higher the current target compression ratio.

This is because even if the amount of change when making the mechanical compression ratio change to the high compression ratio side is the same, the amount of rise of the stoichiometric thermal efficiency when making the mechanical compression ratio change to the high compression ratio side from the state where the mechanical compression ratio is relatively high becomes smaller compared with the amount of rise of the stoichiometric thermal efficiency when making the mechanical compression ratio change to the high compression ratio side from the state where the mechanical compression ratio is relatively low. That is, when changing the target compression ratio from the current target compression ratio to the high compression ratio side, if not making the compression ratio change more from the current target compression ratio to the high compression ratio side the higher the current target compression ratio, an effect of improvement of the fuel efficiency commensurate with the amount of fuel consumed due to driving the motor 65 cannot be obtained.

Further, the added value map is configured so that the added value A becomes larger the higher the engine speed when the current target compression ratio is the same. That is, the added value map is configured so that change of the target compression ratio becomes difficult the higher the engine speed.

This is because the time while the engine body 1 is operated in the state where the engine speed is high is usually short. Since the engine speed becomes high, when changing the mechanical compression ratio to the high compression ratio side, it is often necessary to change the mechanical compression ratio to the low compression ratio side in a short time. That is, if the time maintaining the mechanical compression ratio at a high compression ratio to operate the engine body 1 is short, even if temporarily increasing the mechanical compression ratio to raise the stoichiometric thermal efficiency, an effect of improvement of the fuel efficiency commensurate with the amount of fuel consumed by driving the motor 65 cannot be obtained.

Note that in the present embodiment, the added value A is calculated based on the engine speed and the current target compression ratio, but it is also possible to calculate the added value A based on one of the engine speed and current target compression ratio.

At step S22, the electronic control unit 200 adds the added value A to the current target compression ratio to calculate the permittable changed compression ratio.

FIG. 13 is a flow chart explaining control for setting the flag F1. The electronic control unit 200 repeatedly performs the routine during engine operation by a predetermined processing period Δt (for example 10 ms).

At step S31, the electronic control unit 200 reads the engine load detected by the load sensor 217 and the engine speed calculated based on the output signal of the crank angle sensor 218 and detects the engine operating state.

At step S32, in the same way as step S2 of the above FIG. 10, the electronic control unit 200 refers to a map etc. prepared in advance by experiments etc. and calculates the optimum compression ratio based on the engine operating state.

At step S33, the electronic control unit 200 judges if the flag F1 is set to “0”. The electronic control unit 200 proceeds to step S34 if the flag F1 is set to “0”. On the other hand, the electronic control unit 200 proceeds to step S36 if the flag F1 is set to 1″.

At step S34, the electronic control unit 200 judges if the optimum compression ratio has started to increase. In the present embodiment, the electronic control unit 200 judges that the optimum compression ratio has begun to increase if the optimum compression ratio calculated by the current processing becomes higher than the optimum compression ratio calculated by the previous processing. The electronic control unit 200 proceeds to step S35 if the optimum compression ratio starts to increase. The electronic control unit 200 ends the current processing if the optimum compression ratio has not started to increase.

At step S35, the electronic control unit 200 sets the flag F1 to “1”.

At step S36, the electronic control unit 200 judges if the optimum compression ratio has started to fall. In the present embodiment, the electronic control unit 200 judges that the optimum compression ratio has started to fall if the optimum compression ratio calculated by the current processing becomes lower than the optimum compression ratio calculated by the previous processing. The electronic control unit 200 proceeds to step S37 if the optimum compression ratio has started to fall. The electronic control unit 200 ends the current processing if the optimum compression ratio has not started to fall.

At step S37, the electronic control unit 200 returns the flag F1 to “0”.

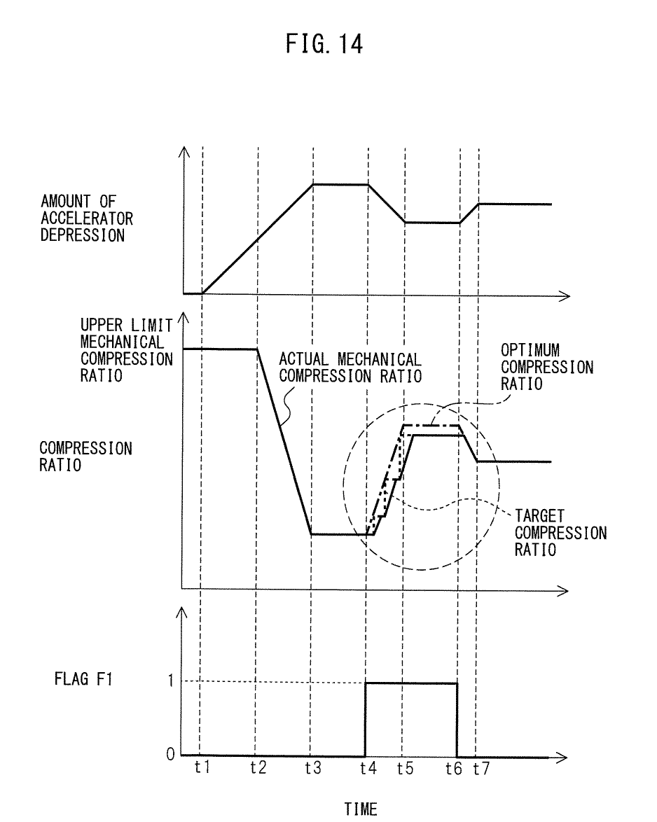

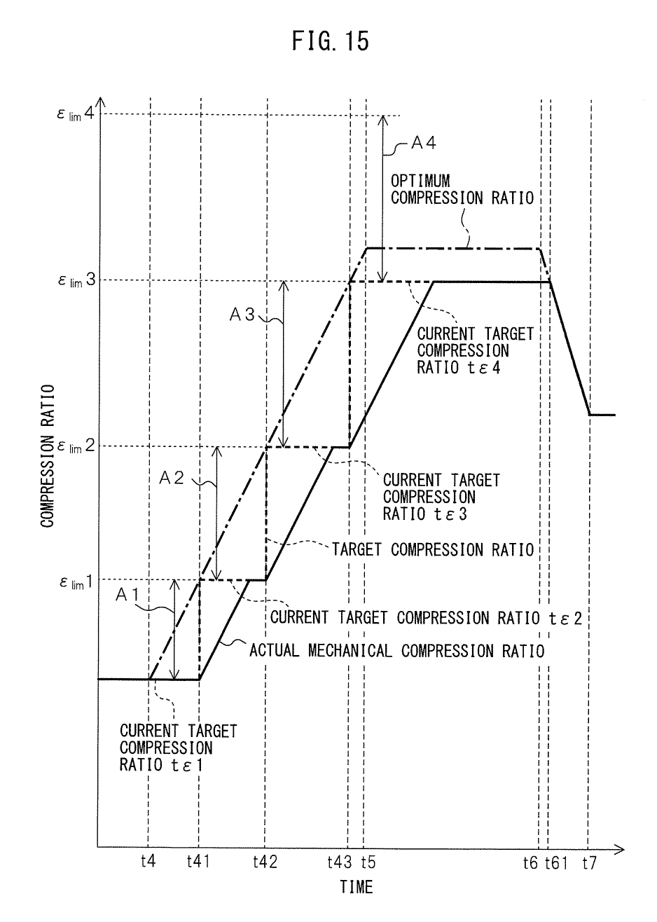

Below, referring to FIG. 14 and FIG. 15, the operation of the compression ratio control according to this present embodiment will be explained. FIG. 14 is a time chart explaining the operation of compression ratio control according to the present embodiment. FIG. 15 is an enlarged view of the part surrounded by the broken line in FIG. 14.

In FIG. 14, before the time t1, it is assumed that the engine body 1 is in an idling state after having been made to start up. Note that in the present embodiment, when stopping the engine body 1, the variable compression ratio mechanism A is controlled so that the mechanical compression ratio becomes the upper limit mechanical compression ratio, while when starting the engine body 1, the target compression ratio is set to the upper limit mechanical compression ratio to make the engine body 1 start.

As shown in FIG. 14, at the time t1, after the accelerator pedal is depressed, the engine operating state changes according to the amount of accelerator depression and the optimum compression ratio changes according to the engine operating state.

Specifically, up to the time t2, the amount of accelerator depression is small (engine load is low) and the engine operating state is in the region of the load line L1 or less of FIG. 8, so the optimum compression ratio becomes the upper limit mechanical compression ratio. At the time t2 and on, if the engine operating state enters the region higher than the load line L1, at the time t3, until the amount of accelerator depression becomes constant and the engine operating state becomes constant, the optimum compression ratio falls from the upper limit mechanical compression ratio along with the increase of the amount of accelerator depression (increase of engine load).

At this time, up until the time t4 where the optimum compression ratio starts to increase after starting the engine body 1, the flag F1 is set to the initial value of “0”. When the flag F1 is set to “0”, except when the optimum compression ratio becomes higher than the current target compression ratio, the optimum compression ratio becomes the target compression ratio. For this reason, as shown in FIG. 14, up to the time t4, the variable compression ratio mechanism A is controlled so that the actual mechanical compression ratio (below, referred to as the “the actual mechanical compression ratio”) matches the optimum compression ratio.

At the time t4 and on, if the amount of accelerator depression decreases, the optimum compression ratio increases along with the reduction of the engine load. Due to this, flag F1 is set to “1”.

If the flag F1 is set to “1”, as shown in FIG. 15, the target compression ratio is maintained at the current target compression ratio until the optimum compression ratio becomes the permittable changed compression ratio or more.

That is, in FIG. 15, at the time t4, if the optimum compression ratio starts to increase and the flag F1 is set to “1”, the added value A1 is calculated based on a current target compression ratio tε1 etc. Further, the target compression ratio is maintained at the current target compression ratio tε1 until the optimum compression ratio becomes the permittable changed compression ratio εₗᵢₘ1 comprised of the current target compression ratio tε1 plus the added value A1 or becomes more.

At the time t41, if the optimum compression ratio becomes the permittable changed compression ratio εₗᵢₘ1 or more, the target compression ratio is changed to the permittable changed compression ratio εₗᵢₘ1 and the variable compression ratio mechanism A is controlled so that the actual mechanical compression ratio becomes the permittable changed compression ratio εₗᵢₘ1.

Further, at the time t41, if the target compression ratio is changed to the permittable changed compression ratio εₗᵢₘ1, at the time t41 and on, the added value A2 is calculated based on the current target compression ratio tε2 (=εₗᵢₘ1) etc. Further, the target compression ratio is maintained at the current target compression ratio tε2 until the optimum compression ratio becomes the permittable changed compression ratio εₗᵢₘ2 comprised of the current target compression ratio tε2 plus the added value A2 or becomes more.

At the time t42, if the optimum compression ratio becomes the permittable changed compression ratio εₗᵢₘ2 or more, the target compression ratio is changed to the permittable changed compression ratio εₗᵢₘ2 and the variable compression ratio mechanism A is controlled so that the actual mechanical compression ratio becomes the permittable changed compression ratio εₗᵢₘ2. Note that, the current target compression ratio tε2 is higher than the current target compression ratio tε1, so the added value A2 basically becomes a value larger than the added value A1.

Further, at the time t42, if the target compression ratio is changed to the permittable changed compression ratio εₗᵢₘ2, at the time t42 and on, the added value A3 is calculated based on the current target compression ratio tε3 (=εₗᵢₘ2) etc. Further, the target compression ratio is maintained at the current target compression ratio tε3 until the optimum compression ratio becomes the permittable changed compression ratio εₗᵢₘ3 comprised of the current target compression ratio tε3 plus the added value A3 or becomes more.

At the time t43, if the optimum compression ratio becomes the permittable changed compression ratio εₗᵢₘ3 or more, the target compression ratio is changed to the permittable changed compression ratio εₗᵢₘ3 and the variable compression ratio mechanism A is controlled so that the actual mechanical compression ratio becomes the permittable changed compression ratio εₗᵢₘ3. Note that, the current target compression ratio tε3 is higher than the current target compression ratio tε2, so the added value A3 basically becomes a value larger than the added value A2.

At the time t43, if the target compression ratio is changed to the permittable changed compression ratio εₗᵢₘ3, the added value A4 is calculated based on the current target compression ratio tε4 (=εₗᵢₘ3) etc. Further, the target compression ratio is maintained at the current target compression ratio tε4 until the optimum compression ratio becomes the permittable changed compression ratio εₗᵢₘ4 comprised of the current target compression ratio tε4 plus the added value A4 or becomes more.

At this time, in the example of FIG. 14 and FIG. 15, at the time t5, the amount of accelerator depression becomes constant and the engine operating state becomes constant. For this reason, at the time t5, the increase of the optimum compression ratio is stopped and the optimum compression ratio becomes constant. As a result, the optimum compression ratio will not become the permittable changed compression ratio εₗᵢₘ4 or more, so the target compression ratio remains maintained at the current target compression ratio tε4 (=εₗᵢₘ3).

In this way, in the compression ratio control according to the present embodiment, when the optimum compression ratio changes to the high compression ratio side along with change of the engine operating state, so long as the optimum compression ratio becomes the permittable changed compression ratio or more, the target compression ratio is changed to the permittable changed compression ratio. Due to this, even if considering the amount of fuel consumed by driving the motor 65, so long as the effect of improvement of the fuel efficiency is obtained, the target compression ratio can be changed to make the actual mechanical compression ratio change to the high compression ratio side.

At the time t6 and on, if the amount of accelerator depression increases, the optimum compression ratio falls along with increase of the engine load. Due to this, the flag F1 is returned to “0”.

Due to this, at the time t6 and on, until the optimum compression ratio falls to the current target compression ratio tε4 at the time t61, the target compression ratio is maintained at the current target compression ratio tε4. Further, at the time t61 and on, the optimum compression ratio becomes the target compression ratio and the variable compression ratio mechanism A is controlled so that the actual mechanical compression ratio matches the optimum compression ratio.

According to the above explained present embodiment, there is provided an electronic control unit 200 (control device) for controlling an internal combustion engine 100 provided with an engine body 1 and a variable compression ratio mechanism A configured to drive a motor 65 to thereby enable change of a mechanical compression ratio of the engine body 1, which control device is provided with a compression ratio control part controlling the mechanical compression ratio to a target compression ratio. Further, the compression ratio control part comprises an optimum compression ratio calculating part calculating an optimum compression ratio in the engine operating state based on the engine operating state, a permittable changed compression ratio calculating part calculating a permittable changed compression ratio higher than a target compression ratio giving the effect of improvement of the fuel efficiency even if considering the amount of fuel consumed by driving the motor 65 when the optimum compression ratio is higher than the target compression ratio, and a target compression ratio changing part changing the target compression ratio to the permittable changed compression ratio when the optimum compression ratio is higher than the target compression ratio and the optimum compression ratio becomes the permittable changed compression ratio or more.

Due to this, when the optimum compression ratio changes to the high compression ratio side along with the change of the engine operating state, the target compression ratio is changed to the permittable changed compression ratio so long as the optimum compression ratio becomes the permittable changed compression ratio or more. For this reason, even if considering the amount of fuel consumed by driving the motor 65, so long as the effect of improvement of the fuel efficiency is obtained, it is possible to change the target compression ratio to make the mechanical compression ratio change to the high compression ratio side. For this reason, by making the mechanical compression ratio change to the high compression ratio side, it is possible to obtain the desired effect of improvement of the fuel efficiency. Further, it is possible to suppress degradation of the motor 65 caused by the motor 65 frequently being driven.

Further, in the present embodiment, the permittable changed compression ratio calculating part is configured provided with an added value calculating part calculating the added value A to be added to the target compression ratio to calculate the permittable changed compression ratio. Further, the added value calculating part is configured to enlarge the added value A more when the target compression ratio is high compared to when it is low.

When changing the target compression ratio from the current target compression ratio to the high compression ratio side, if not making the compression ratio greatly change from the current target compression ratio to the high compression ratio side the higher the current target compression ratio, an effect of improvement of the fuel efficiency commensurate with the amount of fuel consumed by driving the motor 65 cannot be obtained. That is, the permittable changed compression ratio tends to become higher than the current target compression ratio the higher the current target compression ratio. Therefore, in calculating the permittable changed compression ratio comprised of the target compression ratio plus the added value A like in the present embodiment, by increasing the added value more when the target compression ratio is high compared to when it is low, it is possible to calculate a suitable permittable changed compression ratio matching this trend. Therefore, by changing the target compression ratio to the permittable changed compression ratio, it is possible to reliably obtain the effect of improvement of the fuel efficiency.

Further, in the present embodiment, the added value calculating part is further configured so as to enlarge the added value A more when the engine speed is high compared to when it is low.

The time during which the engine body 1 is operated while the engine speed is in the high state is often short. Even if the optimum compression ratio changes to the high compression ratio side along with the rise of the engine speed, in many cases the optimum compression ratio changes to the low compression ratio side in a short time. If the time for maintaining the mechanical compression ratio at a high compression ratio and operating the engine body 1 is short, even if temporarily raising the mechanical compression ratio to raise the stoichiometric thermal efficiency, sometimes an effect of improvement of the fuel efficiency commensurate with the amount of fuel consumed by driving the motor 65 cannot be obtained. Therefore, when calculating the permittable changed compression ratio comprised of the target compression ratio plus the added value A like in the present embodiment, by enlarging the added value A more when the engine speed is high compared to when it is low, it is possible to make it difficult to change the target compression ratio when the engine speed is high. For this reason, it is possible to keep the target compression ratio from changing due to a temporary rise in the engine speed, so it is possible to keep the fuel efficiency from deteriorating.

### Second Embodiment

Next, a second embodiment of the present disclosure will be explained. The present embodiment differs from the first embodiment on the point of reducing the rotational speed of the motor 65 (motor rotational speed) when changing the mechanical compression ratio to the high compression ratio side after the mechanical compression ratio approaches the target compression ratio to a certain extent. Below, the points of difference will be focused on in the explanation.

In the above-mentioned first embodiment, when the target compression ratio is changed to the high compression ratio side and the mechanical compression ratio is changed to the high compression ratio side, the motor rotational speed is made the highest rotational speed and the mechanical compression ratio is controlled toward the target compression ratio (permittable changed compression ratio).

However, when the optimum compression ratio becomes the permittable changed compression ratio or more, if changing the target compression ratio to the permittable changed compression ratio, as shown in FIG. 15, sometimes the target compression ratio is changed in stages. For this reason, if making the motor rotational speed the highest rotational speed when changing the mechanical compression ratio to the high compression ratio, at the stage before the mechanical compression ratio is controlled to the final target compression ratio, sometimes the drive motor is repeatedly stopped and restarted. In the example shown in FIG. 15, at the stage before the mechanical compression ratio is controlled to the final target compression ratio (=permittable changed compression ratio εₗᵢₘ3), the mechanical compression ratio is controlled once to the permittable changed compression ratio εₗᵢₘ1 and permittable changed compression ratio εₗᵢₘ2 and the motor 65 is repeatedly stopped and restarted.

Here, at the time of motor stop when the operating motor 65 is made to completely stop or at the time of motor restart when the stopped motor 65 is restarted, a large amount of power is temporarily consumed. For this reason, at the stage before controlling the mechanical compression ratio to the final target compression ratio, repeated stopping and restart of the motor 65 are desirably avoided as much as possible from the viewpoint of improvement of the fuel efficiency and suppression of degradation of the motor 65.

Therefore, in the present embodiment, when changing the mechanical compression ratio to the high compression ratio side, when the mechanical compression ratio approaches the target compression ratio to a certain extent, the motor rotational speed is made the highest rotational speed, while after the mechanical compression ratio approaches the target compression ratio to a certain extent, the motor rotational speed is made to decrease to a predetermined low rotational speed lower than the highest rotational speed. Below, the motor control according to this present embodiment will be explained.

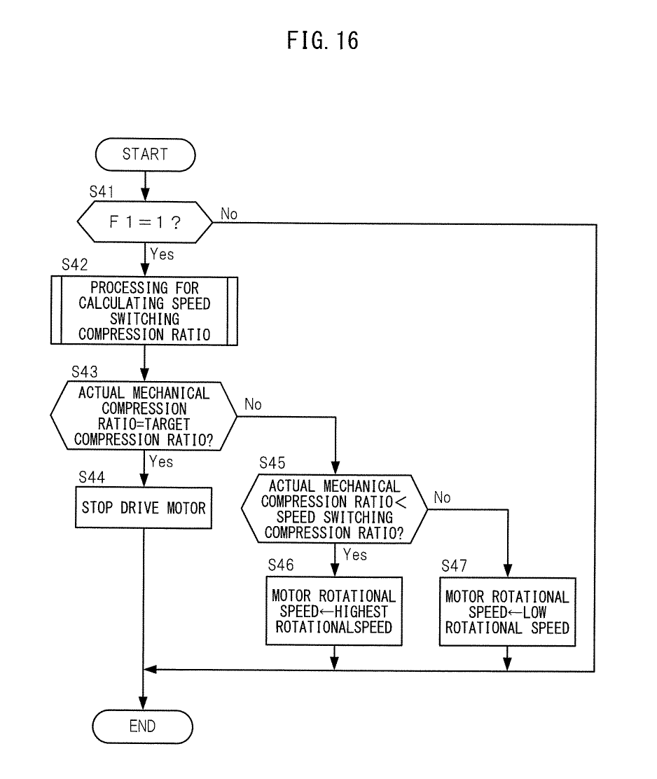

FIG. 16 is a flow chart explaining the motor control according to the present embodiment. The electronic control unit 200 repeatedly performs this routine by a predetermined processing period Δt (for example, 10 ms).

At step S41, the electronic control unit 200 reads the flag F1 and judges if the flag F1 is set to “1”. The electronic control unit 200 proceeds to step S42 if the flag F1 is set to “1”. On the other hand, the electronic control unit 200 ends the current processing if the flag F1 is set to “0”.

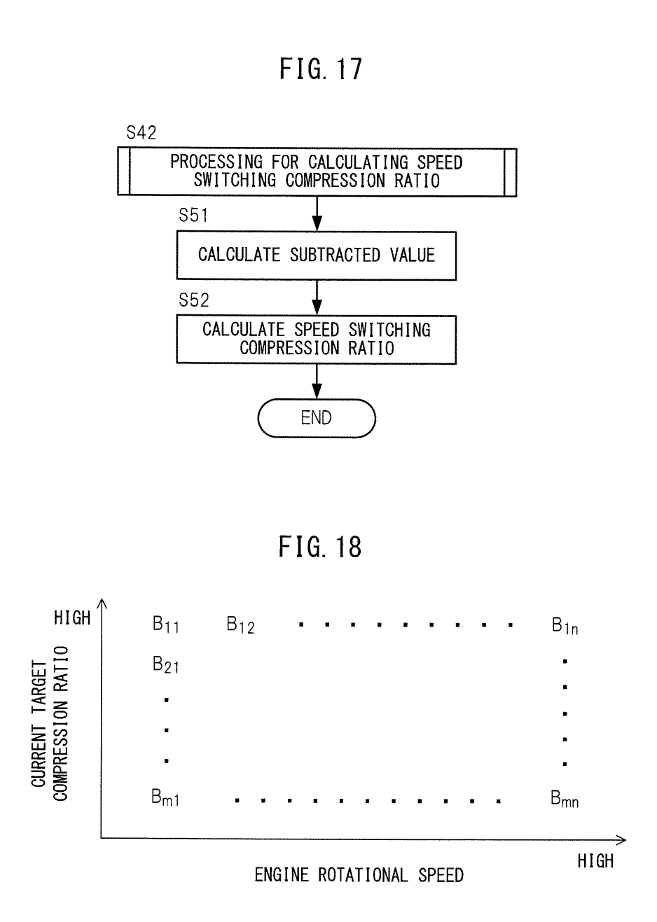

At step S42, the electronic control unit 200 performs processing for calculating the speed switching compression ratio. The processing for calculating the speed switching compression ratio is processing for calculating the compression ratio for switching the motor rotational speed from the highest rotational speed to the low rotational speed when changing the mechanical compression ratio to the high compression ratio side (below, referred to as the “speed switching compression ratio”). Details of the processing for calculating the speed switching compression ratio will be explained later referring to FIG. 17.

At step S43, the electronic control unit 200 judges if the target compression ratio and the actual mechanical compression ratio match. The electronic control unit 200 proceeds to step S44 if the target compression ratio and the actual mechanical compression ratio match. On the other hand, the electronic control unit 200 proceeds to step S45 if the target compression ratio and the actual mechanical compression ratio do not match.

At step S44, the electronic control unit 200 makes the motor 65 stop.

At step S45, the electronic control unit 200 judges if the actual mechanical compression ratio is less than the speed switching compression ratio. The electronic control unit 200 proceeds to step S46 if the actual mechanical compression ratio is less than the speed switching compression ratio. On the other hand, the electronic control unit 200 proceeds to step S47 if the actual mechanical compression ratio is the speed switching compression ratio or more.

At step S46, the electronic control unit 200 controls the motor 65 so that the motor rotational speed becomes the highest rotational speed.

At step S47, the electronic control unit 200 controls the motor 65 so that the motor rotational speed becomes a low rotational speed.

FIG. 17 is a flow chart explaining the content of processing for calculating the speed switching compression ratio.

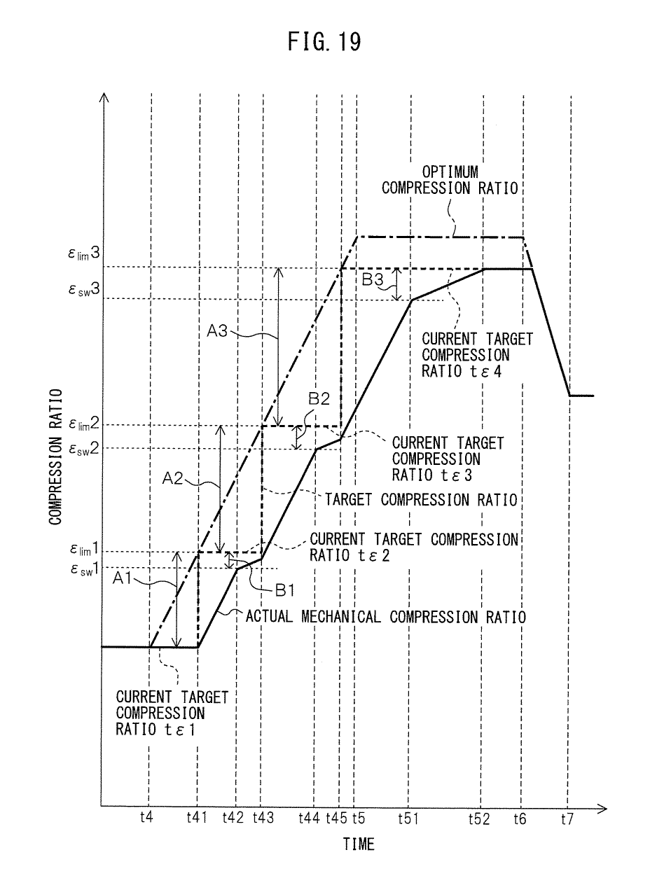

At step S51, the electronic control unit 200 refers to the subtracted value map of FIG. 18 and calculates the subtracted value B to be subtracted from the current target compression ratio to calculate the speed switching compression ratio based on the engine speed and current target compression ratio.

The subtracted value map of FIG. 18, like the added value map, is configured so that, if the engine speed is the same, the subtracted value B becomes larger then higher the current target compression ratio. Conversely speaking, it is configured so that the lower the current target compression ratio, the subtracted value B becomes smaller.

This is because, as explained above, the amount of rise of the stoichiometric thermal efficiency when making the mechanical compression ratio change to the high compression ratio side from the state where the mechanical compression ratio is relatively low becomes larger compared with the amount of rise of the stoichiometric thermal efficiency when making the mechanical compression ratio change to the high compression ratio side from the state where the mechanical compression ratio is relatively high. For this reason, reducing the subtracted value B the lower the current target compression ratio to make the mechanical compression ratio quickly approach the target compression ratio is higher in effect of improvement of the fuel efficiency.

Further, the subtracted value map of FIG. 18, in the same way as the added value map, is configured so that if the current target compression ratio is the same, the higher the engine speed, the larger the subtracted value B.

This is because, as explained above, the time during which the engine body 1 is operated while the engine speed is in the high state is often short. Since the engine speed has become high, when changing the mechanical compression ratio to the high compression ratio side, it is often necessary to change the mechanical compression ratio to the low compression ratio side in a short time. For this reason, when the engine speed is high, even if quickly making the mechanical compression ratio the high compression ratio side target compression ratio, it is liable to become necessary to immediately make the mechanical compression ratio change to the low compression ratio side. This being so, it is necessary to stop and restart the motor 65 and the fuel efficiency ends up deteriorating.

As opposed to this, when the engine speed is high, sometimes it is possible to increase the predetermined value B and prolong the time until the mechanical compression ratio reaches the target compression ratio so as to make the mechanical compression ratio change to the low compression ratio side before the mechanical compression ratio reaches the high compression ratio side target compression ratio and the motor 65 is made to stop. In this case, there is no longer a need for stopping and restarting the motor 65, so deterioration of the fuel efficiency can be prevented. Therefore, in the present embodiment, the subtracted value map is configured so that if the current target compression ratio is the same, the higher the engine speed, the larger the subtracted value B becomes.

Note that in the present embodiment, the subtracted value B is calculated based on the engine speed and the current target compression ratio, but it is also possible to calculate the subtracted value B based on one of the engine speed and current target compression ratio.

At step S52, the electronic control unit 200 subtracts the subtracted value B from the current target compression ratio to calculate the speed switching compression ratio.

FIG. 19 is a time chart explaining the operation of the motor control according to the present embodiment.

In the same way as the first embodiment explained above with reference to FIG. 15, in FIG. 19, at the time t4, if the optimum compression ratio starts to increase and the flag F1 is set to “1”, the target compression ratio is maintained at the current target compression ratio tε1 until the optimum compression ratio becomes the permittable changed compression ratio εₗᵢₘ1 comprised of the current target compression ratio tε1 plus the added value A1 or becomes more.

At the time t41, if the optimum compression ratio becomes the permittable changed compression ratio εₗᵢₘ1 or more, the target compression ratio is changed to the permittable changed compression ratio εₗᵢₘ1 and the variable compression ratio mechanism A is controlled so that the mechanical compression ratio becomes the permittable changed compression ratio εₗᵢₘ1.

Further, at the time t41, if the target compression ratio is changed to the permittable changed compression ratio εₗᵢₘ1, the subtracted value B1 is calculated based on the changed target compression ratio, that is, the current target compression ratio tε2 (=εₗᵢₘ1) etc., and the speed switching compression ratio ε_{sw}1 comprised of the current target compression ratio tε2 minus a predetermined value B1 is calculated.

Further, at the time t41 and on, when controlling the variable compression ratio mechanism A so that the mechanical compression ratio becomes the permittable changed compression ratio εₗᵢₘ1, at the time t42, the motor 65 is controlled so that the motor rotational speed becomes the highest rotational speed until the actual mechanical compression ratio becomes the speed switching compression ratio ε_{sw}1 or more. Further, at the time t42, after the actual mechanical compression ratio becomes the speed switching compression ratio ε_{sw}1 or more, the motor 65 is controlled so that the motor rotational speed becomes a predetermined low rotational speed.

At the time t43, if the optimum compression ratio becomes the permittable changed compression ratio εₗᵢₘ2 comprised of the current target compression ratio tε2 plus the added value A2 or becomes more, the target compression ratio is changed to the permittable changed compression ratio εₗᵢₘ2 and the variable compression ratio mechanism A is controlled so that the mechanical compression ratio becomes the permittable changed compression ratio εₗᵢₘ2.

Further, at the time t43, if the target compression ratio is changed to the permittable changed compression ratio εₗᵢₘ2, the subtracted value B2 is calculated based on the changed target compression ratio, that is, the current target compression ratio tε3 (=εₗᵢₘ2) etc., the speed switching compression ratio ε_{sw}2 comprised of the current target compression ratio tε3 minus the predetermined value B2 is calculated.

Further, at the time t43 and on, when controlling the variable compression ratio mechanism A so that the mechanical compression ratio becomes the permittable changed compression ratio εₗᵢₘ2, at the time t44, the motor 65 is controlled so that the motor rotational speed becomes the highest rotational speed until the actual mechanical compression ratio becomes the speed switching compression ratio ε_{sw}2 or more. Further, at the time t44, after the actual mechanical compression ratio becomes the speed switching compression ratio ε_{sw}2 or more, the motor 65 is controlled so that the motor rotational speed becomes a predetermined low rotational speed.

At the time t45, if the optimum compression ratio becomes the permittable changed compression ratio εₗᵢₘ3 comprised of the current target compression ratio tε3 plus the added value A3 or becomes more, the target compression ratio is changed to the permittable changed compression ratio εₗᵢₘ3 and the variable compression ratio mechanism A is controlled so that the mechanical compression ratio becomes the permittable changed compression ratio εₗᵢₘ3.

Further, at the time t45, if the target compression ratio is changed to the permittable changed compression ratio εₗᵢₘ3, the subtracted value B3 is calculated based on the changed target compression ratio, that is, the current target compression ratio tε4 (=εₗᵢₘ3) etc. and the speed switching compression ratio ε_{sw}3 comprised of the current target compression ratio tε4 minus the predetermined value B3 is calculated.

Further, at the time t45 and on, when controlling the variable compression ratio mechanism A so that the mechanical compression ratio becomes the permittable changed compression ratio εₗᵢₘ3, at the time t51, the motor 65 is controlled so that the motor rotational speed becomes the highest rotational speed until the actual mechanical compression ratio becomes the speed switching compression ratio ε_{sw}3 or more. Further, at the time t51, the actual mechanical compression ratio becomes the speed switching compression ratio ε_{sw}3 or more, then the motor 65 is controlled so that the motor rotational speed becomes a predetermined low rotational speed.

At the time t52, if the target compression ratio and the mechanical compression ratio match, the motor 65 is stopped.

According to the above explained present embodiment, the electronic control unit 200 (control device) is further provided with a motor control part controlling the rotational speed of the motor 65 in addition to the above-mentioned compression ratio control part. Further, the motor control part is configured to retard the rotational speed of the motor 65 after the mechanical compression ratio rises to a speed switching compression ratio lower than the target compression ratio compared with before the mechanical compression ratio rises to the speed switching compression ratio when raising the mechanical compression ratio toward the target compression ratio.

Due to this, even if the target compression ratio is changed in stages, at the stage before the mechanical compression ratio is controlled to the final target compression ratio, it is possible to keep the motor 65 from being repeatedly stopped and restarted. For this reason, it is possible to suppress deterioration of the fuel efficiency and degradation of the drive motor itself due to repeated stopping and restarting of the motor 65.

Further, in the present embodiment, the motor control part is configured to be provided with a subtracted value calculating part calculating a subtracted value B for being subtracted from the target compression ratio to calculate the speed switching compression ratio. Further, the subtracted value calculating part is configured so as to increase the subtracted value B more when the target compression ratio is high compared to when it is low.

The amount of rise of the stoichiometric thermal efficiency when making the mechanical compression ratio change to the high compression ratio side from the state where the mechanical compression ratio is relatively low becomes larger than the amount of rise of the stoichiometric thermal efficiency when making the mechanical compression ratio change to the high compression ratio side from the state where the mechanical compression ratio is relatively high. Therefore, by reducing the subtracted value B the lower the target compression ratio and quickly making the mechanical compression ratio approach the target compression ratio like in the present embodiment, it is possible to effectively obtain the effect of improvement of the fuel efficiency.

Further, in the present embodiment, the subtracted value calculating part is further configured so as to increase the subtracted value B more when the engine speed is high compared to when it is low.

Due to this, when the engine speed is high, sometimes it is possible to prolong the time until the mechanical compression ratio reaches the target compression ratio and make the mechanical compression ratio change to the low compression ratio side before the mechanical compression ratio reaches the high compression ratio side target compression ratio and makes the motor 65 stop. In this case, it is no longer necessary to stop and restart the motor 65, so deterioration of the fuel efficiency can be prevented.

### Third Embodiment

Next, a third embodiment of the present disclosure will be explained. The present embodiment differs in content of processing for calculating a permittable changed compression ratio from the first embodiment and second embodiment. Below, the points of difference will be focused on in the explanation.

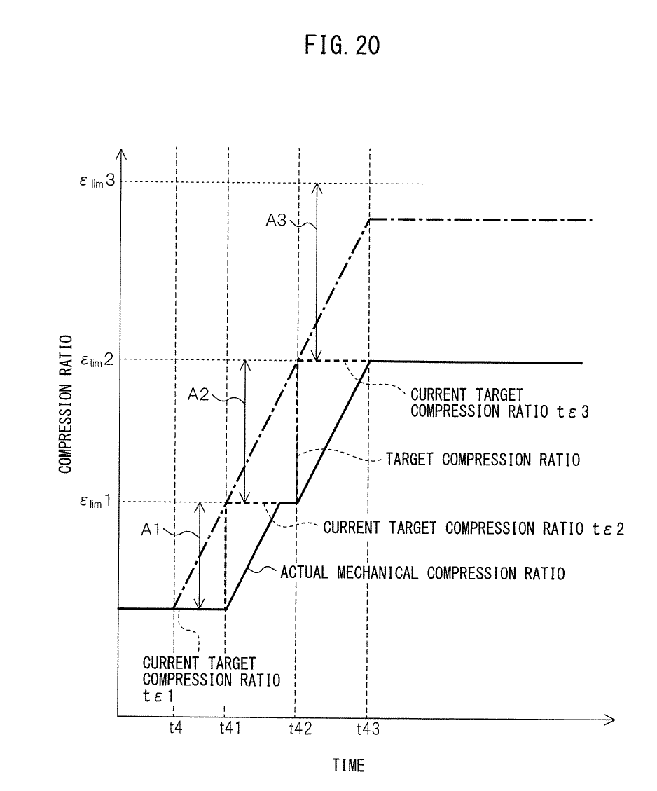

FIG. 20 is a view explaining the problem points of the compression ratio control according to the above-mentioned first embodiment.

In the compression ratio control according to the above-mentioned first embodiment, if the optimum compression ratio does not become the permittable changed compression ratio comprised of the current target compression ratio plus the added value A or becomes more, the target compression ratio is not changed, so, for example, as shown in FIG. 20, at the time t43, if the optimum compression ratio ends up becoming constant at a compression ratio somewhat lower than the permittable changed compression ratio εₗᵢₘ3, there is a possibility of the engine body 1 being operated for a long period of time in a state where the difference between the optimum compression ratio and the current target compression ratio tε3 is relatively large. This being so, the engine body 1 is operated over a long period of time in the state where the stoichiometric thermal efficiency is relatively low, so the fuel efficiency deteriorates.

Therefore, in the present embodiment, to keep the engine body 1 from being operated for a long period of time in the state where the difference between the optimum compression ratio and the current target compression ratio is large, it is possible to correct the added value A to a suitable value.

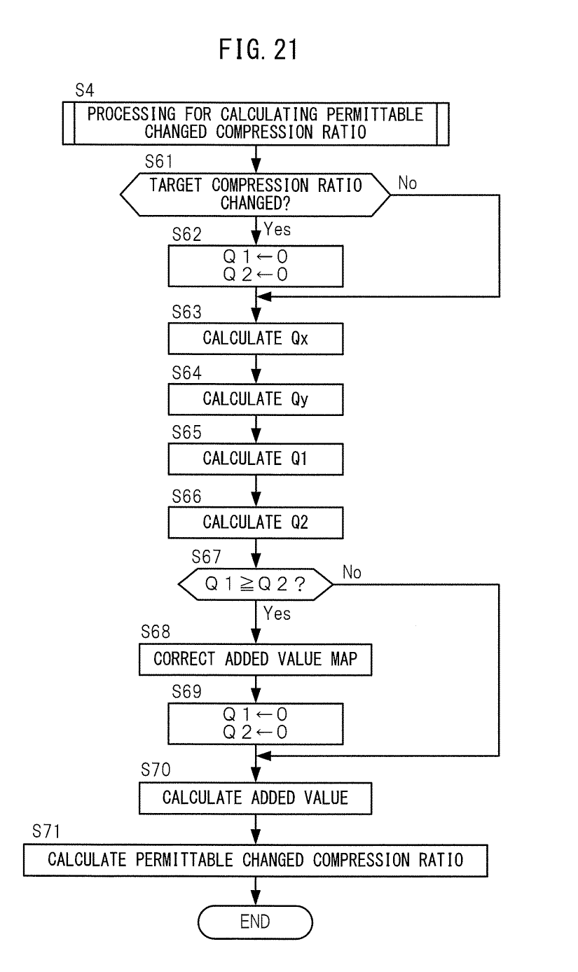

FIG. 21 is a flow chart explaining the content of processing for calculating a permittable changed compression ratio according to the present embodiment. Note that, the content of the compression ratio control according to the present embodiment is similar to that of the first embodiment and is similar to the flow chart of FIG. 10, so here the explanation will be omitted.

At step S61, the electronic control unit 200 judges if the target compression ratio has been changed. The electronic control unit 200 proceeds to step S62 if the target compression ratio has been changed. On the other hand, the electronic control unit 200 proceeds to step S63 if the target compression ratio has not been changed.

At step S62, the electronic control unit 200 returns the later explained lost fuel amount Q1 and compression ratio changing fuel amount Q2 to zero.

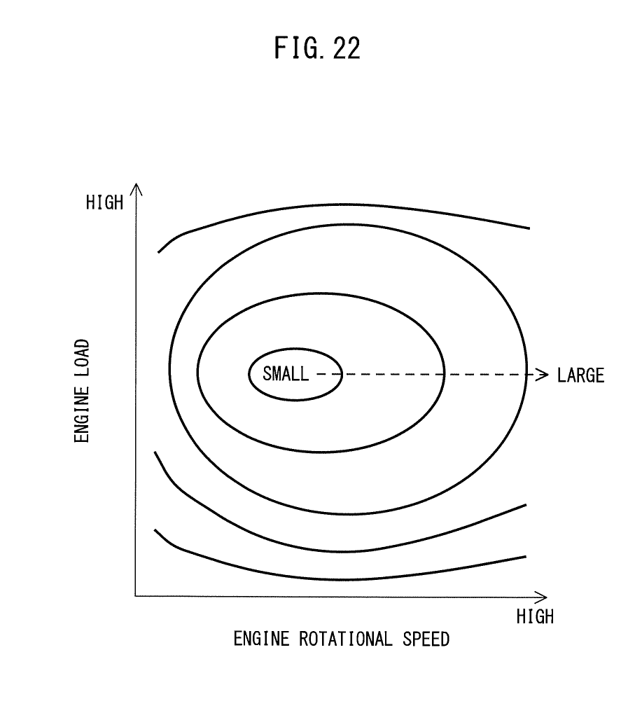

At step S63, the electronic control unit 200 calculates the unit amount of fuel consumption in the current engine operating state Qx[g/s] in the case of operating the engine body 1 by the optimum compression ratio (below, referred to as the “optimum amount of fuel consumption”). In the present embodiment, a map of a unit amount of fuel consumption such as shown in FIG. 22 is prepared for each compression ratio. The electronic control unit 200 reads a map of a unit amount of fuel consumption of the compression ratio corresponding to the current target compression ratio and refers to the read map of a unit amount of fuel consumption to calculate the optimum amount of fuel consumption based on the engine operating state.

At step S64, the electronic control unit 200 calculates the unit amount of fuel consumption Qy in the current engine operating state when operating the engine body 1 by the current target compression ratio (below, referred to as the “current amount of fuel consumption”). In the present embodiment, the electronic control unit 200 reads a map of a unit amount of fuel consumption of the compression ratio corresponding to the current target compression ratio and refers to the read map of a unit amount of fuel consumption to calculate the current amount of fuel consumption based on the engine operating state.

At step S65, the electronic control unit 200 calculates the amount of fuel Q1 consumed in excess by operating the engine body 1 by the current target compression ratio compared with when operating the engine body 1 by the optimum compression ratio (below, referred to as the “lost fuel amount”). In the present embodiment, the electronic control unit 200 calculates the lost fuel amount based on the following formula (1). Note that in formula (1), Q1z is the previous value of the lost fuel amount, while Δt is the processing period of the present routine:

Q1=Q1z+(Qy−Qx)×Δt (1)

At step S66, when changing the mechanical compression ratio from the current target compression ratio to the optimum compression ratio, the electronic control unit 200 multiplies the amount of fuel consumed by driving the motor 65 with a coefficient K (for example 1.5 to 2.5 or so) to calculate the compression ratio changing fuel amount Q2. Note that, when changing the mechanical compression ratio from the current target compression ratio to the optimum compression ratio, it is also possible to use the amount of fuel consumed by driving the motor 65 as the compression ratio changing fuel amount Q2. That is, it is not necessarily required to multiply this with the coefficient K.

In the present embodiment, the electronic control unit 200 first refers to a map etc. prepared by experiments etc. in advance and linking the amount of change of the compression ratio and drive power of the motor 65 to calculate the drive power of the motor 65 required for changing the mechanical compression ratio from the current target compression ratio to the optimum compression ratio. Further, the electronic control unit 200 next refers to a map etc. prepared by experiments etc. in advance and linking the drive power of the motor 65 and the amount of fuel required for generating the drive power to calculate the amount of fuel required for generating the drive power based on the calculated drive power of the motor 65. Further, the electronic control unit 200 finally multiplies this calculated amount of fuel with a coefficient K so as to calculate the compression ratio changing fuel amount Q2.

At step S67, the electronic control unit 200 judges if the lost fuel amount Q1 has become the compression ratio changing fuel amount Q2 or more. If the electronic control unit 200 judges that the lost fuel amount Q1 has become the compression ratio changing fuel amount Q2 or more, it proceeds to step S68. On the other hand, the electronic control unit 200 proceeds to step S70 if the lost fuel amount Q1 is less than the compression ratio changing fuel amount Q2.

At step S68, the electronic control unit 200 updates the added value map of FIG. 12. Specifically, it uses the map of FIG. 12 in which the value of the added value A corresponding to the current engine speed and current target compression ratio is made smaller as the new added value map taking the place of the added value map up to then. Due to this, each time the lost fuel amount Q1 becomes the compression ratio changing fuel amount Q2 or more during engine operation, it is possible to correct the value of the added value A corresponding to the current engine speed and current target compression ratio to a suitable value. In other words, it is possible to learn a suitable value as the value of the added value A corresponding to the current engine speed and current target compression ratio during engine operation.

Note that, as the method of making the value of the added value A corresponding to the current engine speed and current target compression ratio smaller, the method of subtracting a predetermined value from the added value A, the method of making the added value A smaller by a predetermined ratio, etc. may be mentioned. Further, in the present embodiment, a lower limit value is set for the added value A which is then prevented from becoming smaller than the lower limit value.

At step S69, the electronic control unit 200 returns the lost fuel amount Q1 and compression ratio changing fuel amount Q2 to zero.

At step S70, the electronic control unit 200 refers to the added value map and calculates the added value A based on the engine speed and the current target compression ratio. The added value map referred to at this step becomes the updated added value map when the added value map is updated at step S68.

At step S71, the electronic control unit 200 adds the added value A to the current target compression ratio to calculate the permittable changed compression ratio.

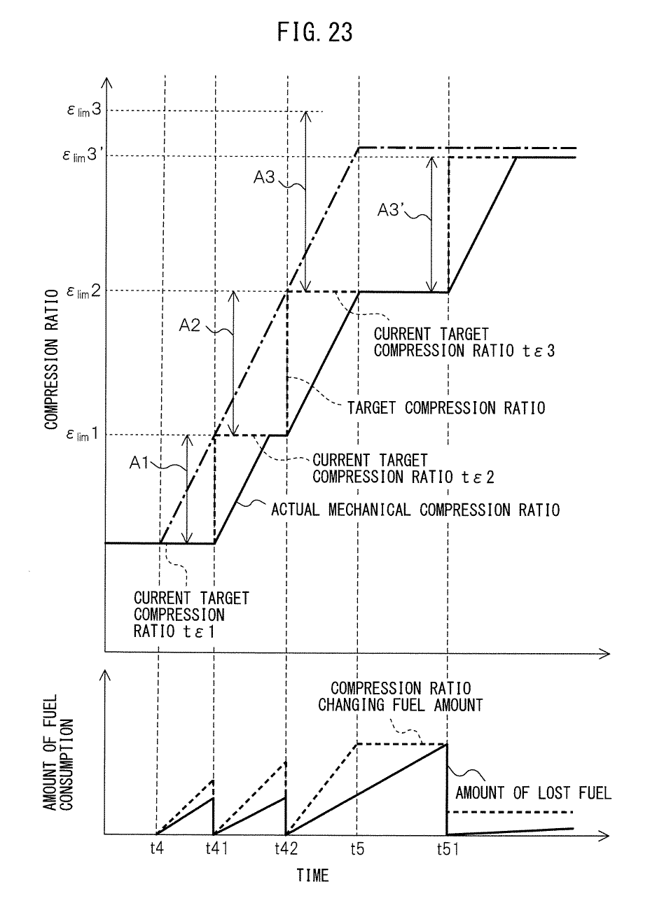

FIG. 23 is a time chart explaining the operation of control of the compression ratio according to the present embodiment.

In the same way as the time of the first embodiment explained above referring to FIG. 15, in FIG. 23, at the time t4, if the optimum compression ratio starts to increase and the flag F1 is first set to “1”, in the present embodiment, the lost fuel amount Q1 and compression ratio changing fuel amount Q2 start to be calculated. Further, while the lost fuel amount Q1 is less than the compression ratio changing fuel Q2, the added value calculated based on the current added value map is added to the current target compression ratio to calculate the permittable changed compression ratio. The target compression ratio is maintained at the current target compression ratio until the optimum compression ratio becomes the permittable changed compression ratio or more.

In the example shown in FIG. 23, at the time t4 and on, the lost fuel amount Q1 and compression ratio changing fuel amount Q2 gradually increase as the difference between the optimum compression ratio and current target compression ratio tε1 becomes larger, but the lost fuel amount Q1 is less than the compression ratio changing fuel Q2, so in the same way as the first embodiment explained above with reference to FIG. 15, the added value A1 calculated based on the current added value map is added to the current target compression ratio tε1 to calculate the permittable changed compression ratio εₗᵢₘ1. The target compression ratio is maintained at the current target compression ratio tε1 until the optimum compression ratio becomes the permittable changed compression ratio εₗᵢₘ1 or more.

At the time t41, if the optimum compression ratio becomes the permittable changed compression ratio εₗᵢₘ1 or more, the target compression ratio is changed to the permittable changed compression ratio εₗᵢₘ1 and the added value A2 calculated based on the current added value map is added to the current target compression ratio tε2 (=εₗᵢₘ1) to calculate the permittable changed compression ratio εₗᵢₘ2. Further, in the present embodiment, at the time t41, if the target compression ratio is changed to the permittable changed compression ratio εₗᵢₘ1, the lost fuel amount Q1 and compression ratio changing fuel amount Q2 are returned once to zero.

At the time t41 and on, the lost fuel amount Q1 and compression ratio changing fuel amount Q2 again gradually increase the greater the difference between the optimum compression ratio and the current target compression ratio tε2 becomes. The lost fuel amount Q1 is less than the compression ratio changing fuel Q2, so the target compression ratio is maintained at the current target compression ratio tε2 until the optimum compression ratio becomes the permittable changed compression ratio εₗᵢₘ2 or more without correcting the added value map.

At the time t42, if the optimum compression ratio becomes the permittable changed compression ratio εₗᵢₘ2 or more, the target compression ratio is changed to the permittable changed compression ratio εₗᵢₘ2, the added value A3 calculated based on the current added value map is added to the current target compression ratio tε3 (=εₗᵢₘ2) whereby the permittable changed compression ratio εₗᵢₘ3 is calculated. Further, in the present embodiment, if, at the time t42, the target compression ratio is changed to the permittable changed compression ratio εₗᵢₘ2, the lost fuel amount Q and compression ratio changing fuel amount are returned once to zero.

At the time t42 and on, the lost fuel amount Q1 and compression ratio changing fuel amount Q2 again gradually increase as the difference between the optimum compression ratio and the current target compression ratio becomes larger. Further, at the time t5, if the increase in the optimum compression ratio stops, the increase in the compression ratio changing fuel amount Q2 also stops and, at the time t5 and on, the compression ratio changing fuel amount Q2 becomes constant.

As a result, at the time t51, if the lost fuel amount Q1 becomes the compression ratio changing fuel amount Q2 or more, the added value map is corrected and the current target compression ratio tε3 plus the added value A3′ calculated based on the corrected added value map is newly set as the permittable changed compression ratio εₗᵢₘ3′. Due to this, in the example shown in FIG. 23, the optimum compression ratio becomes the permittable changed compression ratio or more, the target compression ratio is changed to the permittable changed compression ratio εₗᵢₘ3′, and the variable compression ratio mechanism A is controlled so that the mechanical compression ratio becomes the permittable changed compression ratio εₗᵢₘ3′.

The compression ratio control part of the electronic control unit 200 (control device) according to the above explained present embodiment is configured provided with the above-mentioned optimum compression ratio calculating part, permittable changed compression ratio calculating part, and target compression ratio changing part. Further, in the present embodiment, the permittable changed compression ratio calculating part is configured provided with a lost fuel calculating part calculating an amount of lost fuel Q1 excessively consumed when controlling the mechanical compression ratio to the permittable changed compression ratio to operate the engine body 1 compared to when controlling the mechanical compression ratio to the optimum compression ratio to operate the engine body 1, a compression ratio changing fuel amount calculating part configured to calculate a compression ratio changing fuel amount Q2 consumed by driving the motor 65 when changing the mechanical compression ratio from the target compression ratio to the optimum compression ratio, and an added value learning part configured to learn how to reduce the added value when the lost fuel amount Q1 becomes the compression ratio changing fuel amount Q2 or more.

Due to this, each time the lost fuel amount Q1 becomes the compression ratio changing fuel amount Q2 or more during engine operation, it is possible to correct the added value A corresponding to the current engine speed and current target compression ratio to a suitable value. In other words, it is possible to learn a suitable value as the value of the added value A corresponding to the current engine speed and current target compression ratio during engine operation. For this reason, when the difference between the optimum compression ratio and the current target compression ratio is large, it is possible to keep the engine body 1 from operating over a long period of time, so it is possible to keep the fuel efficiency from deteriorating.

Above, embodiments of the present invention were explained, but the above embodiments only show some of the examples of application of the present invention. The technical scope of the present invention is not limited to the specific constitutions of the above embodiments.

1. A control device for an internal combustion engine for controlling an internal combustion engine provided with:
an engine body; and
a variable compression ratio mechanism configured to drive a motor to thereby enable change of a mechanical compression ratio of the engine body,
which control device comprises a compression ratio control part configured to control the mechanical compression ratio to a target compression ratio,
the compression ratio control part comprising:
an optimum compression ratio calculating part configured to calculate an optimum compression ratio in the engine operating state based on the engine operating state;
a permittable changed compression ratio calculating part configured to calculate a permittable changed compression ratio higher than the target compression ratio giving the effect of improvement of the fuel efficiency even if considering the amount of fuel consumed by driving the motor when the optimum compression ratio is higher than the target compression ratio; and
a target compression ratio changing part configured to change the target compression ratio to the permittable changed compression ratio when the optimum compression ratio is higher than the target compression ratio and the optimum compression ratio becomes the permittable changed compression ratio or more.

2. The control device for an internal combustion engine according to claim 1, wherein
the permittable changed compression ratio calculating part comprises an added value calculating part configured to calculate an added value for addition to the target compression ratio to calculate the permittable changed compression ratio, and
the added value calculating part is configured to increase the added value more when the target compression ratio is high compared to when it is low.

3. The control device for an internal combustion engine according to claim 2, wherein
the added value calculating part is further configured to increase the added value more when the engine speed is high compared to when it is low.

4. The control device for an internal combustion engine according to claim 1, wherein
the permittable changed compression ratio calculating part is provided with an added value calculating part configured to calculate an added value for addition to the target compression ratio to calculate the permittable changed compression ratio, and
the added value calculating part is configured to increase the added value more when the engine speed is high compared to when it is low.

5. The control device for an internal combustion engine according to claim 2, wherein
the permittable changed compression ratio calculating part further comprises:
a lost fuel amount calculating part configured to calculate an amount of lost fuel excessively consumed when controlling the mechanical compression ratio to the permittable changed compression ratio to operate the engine body compared to when controlling the mechanical compression ratio to the optimum compression ratio to operate the engine body;
a compression ratio changing fuel amount calculating part configured to calculate a compression ratio changing fuel amount consumed by driving the motor when changing the mechanical compression ratio from the target compression ratio to the optimum compression ratio; and
an added value learning part configured to learn how to reduce the added value when the lost fuel amount becomes the compression ratio changing fuel amount or more.

6. The control device for an internal combustion engine according to claim 1, wherein
the control device further comprises a motor control part configured to control a rotational speed of the motor, and
the motor control part is configured to slow the rotational speed of the motor after the mechanical compression ratio rises to a speed switching compression ratio lower than the target compression ratio compared with before the mechanical compression ratio rises to the speed switching compression ratio when raising the mechanical compression ratio toward the target compression ratio.

7. The control device for an internal combustion engine according to claim 6, wherein
the motor control part comprises a subtracted value calculating part configured so as to calculate a subtracted value to be subtracted from the target compression ratio to calculate the speed switching compression ratio, and
the subtracted value calculating part is configured so as to increase the subtracted value more when the target compression ratio is high compared to when it is low.

8. The control device for an internal combustion engine according to claim 7, wherein
the subtracted value calculating part is further configured so as to increase the subtracted value more when the engine speed is high compared to when it is low.

9. The control device for an internal combustion engine according to claim 6, wherein
the motor control part comprises a subtracted value calculating part configured so as to calculate a subtracted value to be subtracted from the target compression ratio to calculate the speed switching compression ratio, and
the subtracted value calculating part is configured so as to increase the subtracted value more when the engine speed is high compared to when it is low.
